(19) United States
(12) Patent Application Publication
(10) Pub. No.: US 2020/0073011 A1
(43) Pub. Date: Mar. 5, 2020

(54) Indoor Human Detection and Motion Tracking Using Light Reflections

(71) Applicants: Khadige Abboud, Somerville, MA (US); Yang Li, Georgetown, MA (US); Sergio Bermudez, Boston, MA (US)

(72) Inventors: Khadige Abboud, Somerville, MA (US); Yang Li, Georgetown, MA (US); Sergio Bermudez, Boston, MA (US)

(73) Assignee: OSRAM SYLVANIA Inc., Wilmington, MA (US)

(21) Appl. No.: 16/119,256

(22) Filed: Aug. 31, 2018

(51) Int. Cl. G01V 8/20; G01P 3/36

(52) U.S. Cl. CPC G01V 8/20; G05B 19/0428; G01P 3/36

(57) ABSTRACT

Techniques are disclosed for detecting human presence and tracking motion within a given area using light reflections. Activity is detected by receiving light encoded with source-identifying data reflected from the area and sensing changes, caused by human presence in the area, from a previously established baseline in the light reflection profile for the area. The baseline is updated over time based on human movement and/or as the area changes. Location-indicative changes in the current baseline that are greater than a certain threshold indicate a change in occupancy state of that location. In some embodiments, lightguides are used to define a specific field-of-view for the sensors. The combination of a known field-of-view and a known source of reflected light allows location of each occupant's activity to be tracked within the area. Occupancy can be detected or inferred based on activity tracked entering the area followed by lack of an exit event.

### FIELD OF THE DISCLOSURE

This disclosure relates to presence and motion detection techniques, and more specifically to systems and methods capable of detecting and tracking human presence and motion using visible light reflections.

### BACKGROUND

In occupancy systems, signals such as light and/or sound may be used to detect a human presence and motion within a scanned space. Accurately detecting a human presence and motion without intrusive cameras or on-person devices involves a number of non-trivial challenges.

### BRIEF DESCRIPTION OF THE DRAWINGS

FIG. 1 is a block diagram illustrating an example human motion detection system 10 using light-based communication (LCom) configured in accordance with an embodiment of the present disclosure.

FIG. 2A is a block diagram illustrating an LCom-enabled luminaire 100a configured in accordance with an embodiment of the present disclosure.

FIG. 2B is a block diagram illustrating an LCom-enabled luminaire 100b configured in accordance with another embodiment of the present disclosure.

FIG. 3 illustrates an example transmission and receipt of light encoded with a source ID as may be transmitted and/or received by an LCom-enabled luminaire 100, in accordance with an embodiment of the present disclosure.

FIG. 4 illustrates a method for human detection and motion tracking, in accordance with an embodiment of the present disclosure.

FIGS. 5A and 5B illustrate an example scenario using reflected light to detect human presence and location within an area, in accordance with an embodiment of the present disclosure.

FIG. 6A illustrates a top-down view of an example human detection and tracking system using reflected light, in accordance with an embodiment of the present disclosure.

FIGS. 6B and 6C each illustrate a perspective view of an example human detection and tracking system using reflected light, in accordance with an embodiment of the present disclosure.

FIGS. 7A and 7B respectively illustrate a perspective view of an example human detection and tracking system using reflected light at a time T=1 (FIG. 7A), and a chart showing sensor data readings from luminaire 604 at T=1 (FIG. 7B), in accordance with an embodiment of the present disclosure.

FIGS. 8A and 8B respectively illustrate a perspective view of an example human detection and tracking system using reflected light at a time T=2 (FIG. 8A), and a chart showing sensor data readings from luminaire 604 at T=2 (FIG. 8B), in accordance with an embodiment of the present disclosure.

FIGS. 9A and 9B respectively illustrate a perspective view of an example human detection and tracking system using reflected light at a time T=3 (FIG. 9A), and a chart showing sensor data readings from luminaire 604 at T=3 (FIG. 9B), in accordance with an embodiment of the present disclosure.

FIGS. 10A and 10B respectively illustrate a perspective view of an example human detection and tracking system using reflected light at a time T=4 (FIG. 10A), and a chart showing sensor data readings from luminaire 604 at T=4 (FIG. 10B), in accordance with an embodiment of the present disclosure.

FIG. 11 is a chart showing an example of sensor data readings from all luminaires in a given space at a given time, in accordance with an embodiment of the present disclosure.

FIG. 12 is an oscilloscope plot that represents a reflected light signal as received by a photosensor of an LCom-enabled luminaire from an unoccupied area, in accordance with an embodiment of the present disclosure.

FIG. 13 is an oscilloscope plot that represents a reflected light signal as received by a photosensor of an LCom-enabled luminaire from an area occupied by a person, in accordance with an embodiment of the present disclosure.

### DETAILED DESCRIPTION

Techniques are disclosed for detecting human presence and tracking motion within a given area using light reflections. Activity is detected by receiving light encoded with source-identifying data reflected from the area and sensing changes in the baseline reflection profile, caused by human presence in the area, from a previously established baseline in the light reflection profile. In particular, by comparing the most recently received reflected light signal data with a current baseline signal, the system is able to detect changes in the sensed reflections, which indicates presence (in a previously unoccupied area) or motion (from one location to another within the area). The baseline is updated over time based on human movement and/or as the area changes. Identifying the location of the luminaire that sourced the detected light allows tracking of activity to and from specific locations within the area. In some embodiments, a specific field-of-view for the sensors is provisioned by lightguides. The lightguide effectively limits the physical area from which the sensor can receive reflected light. The combination of a known field-of-view and a known source of reflected light allows location of activity to be tracked within the area. Occupancy can be detected or inferred based on activity tracked entering the area.

General Overview

As previously explained, signals such as light and/or sound may be used to detect a human presence and motion within a scanned space; however, these systems often rely on specialized, expensive, and intrusive means of sensing the human presence. For example, some systems may use cameras or sensors either worn or otherwise carried on-person, or require relatively aggressive retrofitting of equipment into the scanned space. Such systems tend to suffer from excessive computational complexity, poor accuracy, privacy concerns, and/or a relatively high cost of deployment. For example, camera-based approaches raise privacy concerns for occupants, and imaging systems are relatively expensive and computationally complex. Motion tracking systems utilizing wearable or on-person sensors or transmitters such as those involving activity tracking devices like smartphones, wireless-enabled wristbands, and received signal strength indicator (RSSI) transmitters are powerful, but require separate devices for all humans being monitored, and also may be perceived as burdensome and privacy-invasive. Furthermore, scaling presents a relatively large increase in cost and complexity. In addition, on-person devices introduce further potential points of failure by requiring separate power sources. Some systems, such as RSSI and radio frequency (RF) reflection-based tracking may require additional specialized equipment installed in the scanned space, leading to a high cost of deployment. In addition, RSSI is prone to limited accuracy and requires installation of multiple receivers with known location across the room. RF systems are relatively computationally complex and require several RF radios and receivers with directional antennas, which are subject to RF interference.

Thus, improved human presence detection and tracking techniques are herein disclosed. The human presence detection and motion tracking are accomplished using light reflections. In more detail, source identifying data (source ID) is encoded in the light emitted into an area by each of a number of light sources (e.g., luminaires). The emitted light may be visible and/or non-visible light. Light sensors associated with the light sources (e.g., photosensors contained within or otherwise adjacent to the luminaires, such as photodiodes, photocells, phototransistors, and/or photomultipliers) receive light from the light sources that is reflected off a surface in the area to create sensor data. The source ID encoded in the reflected light allows a processor to associate each occurrence of reflected light with a specific light source, and therefore a specific location within the area. As such, changes in the sensor data, indicating changes in the reflections due to human activity in the area can therefore be used to detect human presence and motion in the area.

In some embodiments, the sensor data can be periodically collected from both static environments (without human presence) and dynamic environments (with human presence) to create a current or running baseline signal or profile for each of the light sources at each of the light sensors. Subsequent signals of reflected light can thus be sampled and compared with corresponding baseline signals to detect human presence (when comparison indicates a change from static to dynamic environment) and motion (when comparison indicates a change from a first dynamic environment to a second dynamic environment) within the area. So, for example, activity local to a specific location within the area can be detected based on the sensors and the light sources indicating motion into or out of that location based on a deviation from the current baseline corresponding to that location, according to an embodiment. The baseline can be updated once the motion is detected to enable ongoing detections of subsequent motion in a relative fashion. As will be appreciated in light of this disclosure, periodically updating the baseline allows for, among other things, differentiation between a human that is moving into or out of an area and a human that is relatively stationary in that area. As will be further appreciated, periodically updating the baseline captures any changes to the static/unoccupied environment, such as a moved chair or the addition of a package on a desk surface or some other object added into the area.

In some embodiments, lightguides are used so that the sensors and/or light sources correspond to certain locations within the area being monitored (e.g., room or floor of an office building). For instance, a shaped cone or cap may be coupled with a given sensor to define a specific field-of-view (FOV) of that sensor, thereby limiting the reflected light that sensor can receive to light from a specific known location within the area. The cone or cap or other lightguide can be shaped or otherwise configured to spatially correspond to a specific space within the area. For instance, in one example embodiment, each ceiling-based luminaire is configured with a downward-facing lightguide proximate the sensor. The lightguides can be shaped and arranged so as to collectively provide full sensor coverage of the area being monitored, as explained herein. Note that lightguides can be shaped (e.g., round, square, rectangular, polygonal-shaped, or irregular-shape) so as to correspond to the shape of the area to be monitored by the corresponding sensor. Further note that the FOVs of the lightguides can overlap with one another and that is fine, as such overlap assists in tracking of an occupant from one location in the area to another.

In any such cases, changes in amplitude of reflected light relative to a current baseline can be used to indicate changes in the area covered by the FOV. The changes directly indicate human presence and motion. Moreover, once human presence is detected, that presence may continue to be inferred (even if the human is perfectly still) until the human either moves or exits the area, thereby causing yet another deviation from the current baseline. As will be further appreciated, the techniques provided herein allow tracking across the area by identifying motion across multiple specific locations within the area over time through the use of multiple light sources and sensors associated with different locations.

As will be appreciated, the techniques disclosed herein can be implemented utilizing light-based communication (LCom), such as a system including LCom-enabled light sources (e.g., luminaires) operatively coupled with photosensors and a processor. LCom-enabled light sources can be relatively easily installed in existing light fixtures, offering a ubiquitous, low cost, and non-intrusive system. As will be further appreciated, the techniques disclosed herein allow for occupancy detection and tracking of occupants without impinging upon the privacy of occupants and without necessitating on-person sensors or devices. As previously noted, the light utilized in LCom may be of any spectral band, visible or otherwise, and may be of any intensity, as desired for a given target application or end-use.

In some embodiments, LCom is implemented with visible light, utilizing visible light communications (VLC). Visible light is generally in the frequency band between about 428 THz and about 750 THz. In at least one embodiment, the light source and photosensor are packaged or otherwise contained within or on the housing of the luminaire, resulting in a relatively low cost, self-contained LCom-enabled apparatus. To this end, note that some embodiments provided herein are designed to fit existing lighting infrastructure, offering a solution with low deployment costs. As will be further appreciated, note that the use of VLC allows the light sources to provide illumination to the area while also providing encoded light for use in occupancy detection and tracking as discussed herein. Furthermore, VLC does not interfere with, nor receive interference from, the scarcely available radio spectrum (Wi-Fi, Bluetooth, cellular devices, etc.). Also, a VLC signal is effectively contained within the walls of illuminated area (based on line-of-sight), which enhances communication security by limiting the ability to intercept VLC communications outside the given area. As previously explained, other embodiments may use non-visible light (e.g., infrared).

So, in operation according to one example embodiment, visible light encoded with a source ID is transmitted into the area being both illuminated and monitored. Invariably, the light reflects off the surfaces, objects, and possibly occupants in the area, and is received at light-guided photosensors. Any reflected light outside the FOV of a given photosensor is blocked by the corresponding lightguide, and in this way the photosensor only receives reflected light within its targeted FOV within the area. Because the reflected light is encoded with the light source ID, the received light can be decoded and associated with a specific known light source. Thus, a baseline or profile of light can be established between that light source/photosensor pair, at any given occupancy state. This in turns allows changes in the occupancy state within the specific location covered by that light source and photosensor pair, whether the change is a change: from unoccupied to occupied; or occupied to occupied (different baseline, but still occupied); or from occupied to unoccupied. Given a network of such light source/photosensor pairs, each pair corresponding to a specific location within the monitored area, movement of any occupants can be tracked. For instance, if the occupancy state of a first location transitions from occupied to unoccupied and the occupancy state of a neighboring second location transitions from unoccupied to occupied, then the occupant can be tracked as having moved from the first location to the second.

In addition to detecting occupancy and tracking motion from one location to the next in a given area, in some further embodiments, the shape of the detection signal generated by the photosensor (such as seen and measured on, for instance, an oscilloscope) may be used to extract additional information that can identify the type of motion (e.g., slow, fast, dwell) the occupant is taking. For example, the speed of the occupant passing through a given area can be extracted or otherwise determined from the change of the signal amplitude over time. Likewise, the amount of time an occupant remains (dwells) in a given location can be determined based on the duration of the changed signal amplitude.

In any such embodiments, reflected signals from the indoor environment may be collected, processed, and stored in a local or remote (cloud-based) database to create a baseline reference that identifies the state of the current environment for each light source illuminating the area, when the area is unoccupied. For example, a baseline of a given environment may include signals reflected off stationary and quasi-stationary items such as chairs, desks and bookcases and other furniture, walls, and other such contents of the area. Such items, for the most part, are static and move relatively little or not at all. In addition, signals varying from the currently established baseline of such static items can be used to indicate a dynamic event in the environment, such as a human walking into the environment thereby causing changes in the reflected visible light profile. Once such occupancy is detected, the baseline can be updated to reflect the presence and location of current occupant(s), and in that way, allow the system to detect further changes from that updated baseline, including changes that return the environment back to the original (static) baseline, and changes that cause a new dynamic state in the environment such as when occupants(s) move from one location to another. The baseline may be updated periodically, such as every 1 second, 5 seconds, 10 seconds, or other suitable interval, with the period being configurable in some embodiments. Changes in the baseline indicating a change in state at a given location within the area, such as a change from occupied to unoccupied or vice-versa, can be detected by comparing current photosensor signal values to the current baseline for a particular signal source/photosensor pair. In some embodiments, a minimum change threshold can be used to filter out false indications of presence.

In an example embodiment, when motion is detected by a luminaire, the detection signal is transmitted to a central decision unit (which may be, for example, one or more processors communicatively coupled to the luminaire, such as a cloud-based computing device or in a local luminaire having master control status). The central decision unit processes the detection signal to determine occupancy status for the corresponding location. Alternatively, the luminaire may process the detection signal locally and transmit the occupancy status determination to the central decision unit. In some embodiments, the central decision unit is configured to determine, for instance, direction of motion and the number of occupants, by aggregating the occupancy states from all the luminaires monitoring the space. In some such cases, the central decision unit can assume no occupancy for luminaires that do not transmit a change in occupancy status (i.e., did not detect movement into or out of the corresponding location). As previously explained, the occupancy states of each location can be stored in a database and may be used to enable real-time tracking of occupants within the area by temporal comparison between consecutive signal readings and/or data.

The techniques provided herein may allow control of building systems (e.g., lighting, HVAC, safety/alarm, surveillance/monitoring), by using presence or tracking data to determine when systems should be turned on, off, or otherwise controlled. For example, lighting may be turned off shortly after a no occupancy determination is made. In another example, an air-conditioning system may be controlled to provide greater cooling if the tracking data indicates the presence of the number of occupants in a room exceeding a given threshold. Systems controlled at least in part by the occupancy-based data may therefore be automatically controlled with a greater degree of finesse compared to traditional systems, and thus offer increased energy efficiency among other benefits.

System Architecture and Operation

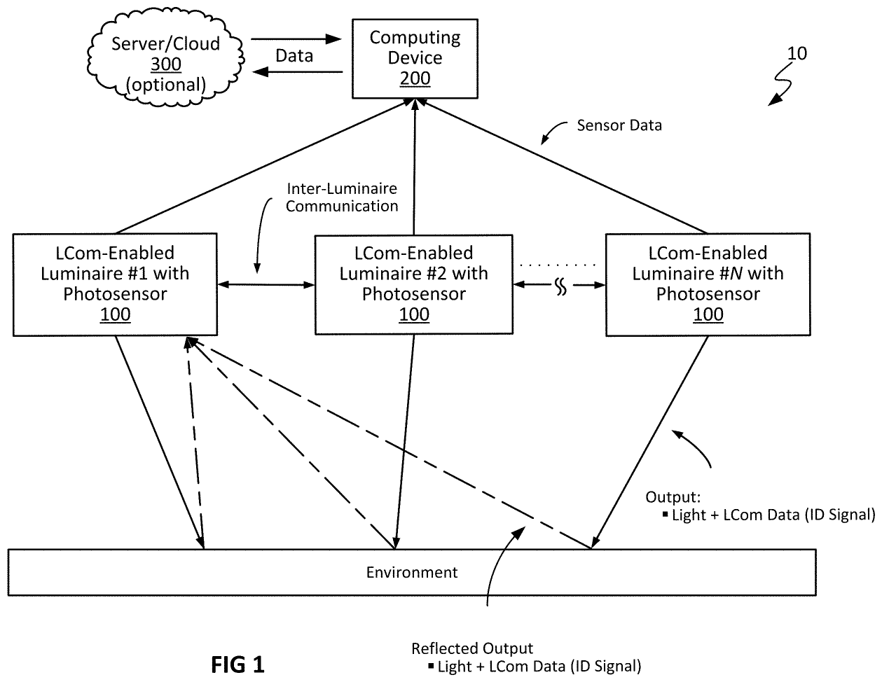

FIG. 1 is a block diagram illustrating an example human motion detection system 10 using light-based communication (LCom) configured in accordance with an embodiment of the present disclosure. As can be seen, system 10 includes one or more LCom-enabled luminaires 100 configured for communicative coupling with a processor, such as computing device 200. As can be further seen, the various luminaires 100 emit light into the environment and receive reflected light back. Only luminaire #1 (far left) is shown as receiving reflected light, but each luminaire 100 may receive such reflections, as will be appreciated in light of this disclosure. The reflected light is processed and used to determine occupancy within the environment and may further be used to track one or more occupants from one location to the next within the environment. The environment can be any area where the one or more luminaires 100 can be deployed, such as an office space, a home, a warehouse, a medical facility, or an apartment building, to name a few examples. Further note that the environment may be a multilevel structure, with stairwells or stair cases between floors, elevators, conference rooms, offices, bedrooms, living areas area, etc, with each of those different locations monitorable by one or more LCom-enabled luminaires 100.

Communicative coupling between device 200 and luminaires 100 may be unidirectional or bidirectional and may occur via any suitable communication methods, such as LCom (visible and/or invisible), wired links (e.g., Ethernet, cable, fiber optic, etc), long-range wireless links (e.g., RF links), short-range wireless links (e.g., 802.11 link, Bluetooth link), or a proprietary communication link. In the embodiment shown, computing device 200 is local to the luminaires 100, and communicates to a cloud-based server 300 via a large area network such as the Internet or a campus-wide network. In such cases, at least some storage and/or processing can be carried out on the server 300. In other embodiments, all processing and/or storage is carried out on the computing device 200. In some cases, in which system 10 includes a plurality of LCom-enabled luminaires 100, all (or some sub-set of) the luminaires 100 may be configured for communicative coupling with one another to provide inter-luminaire communication (via, for example, an LCom link or wired link or wireless link).

In one example embodiment, each of the luminaires 100 generates a unique ID signal identifying the luminaire 100 as the source of the signal. In some such cases, for example, each luminaire outputs visible light encoded with its unique ID signal into the environment. In other embodiments, invisible encoded light is emitted separately from the luminaire visible light but closely adjacent to and parallel with the luminaire light or otherwise arranged so that the invisible encoded light will have a similar reflection path as the visible light. As will be appreciated, each luminaire 100 is associated with a physical location within the environment. Thus, being able to identify the source of light reflected from the environment allows spatial determinations to be made about that light.

In addition, according to some such embodiments, each of luminaires 100 further includes or is otherwise associated with at least one photosensor to detect the reflected output of one or more luminaires 100 (the same luminaire and/or one or more different luminaires). In some cases, each luminaire is further configured to identify the source of the reflected output using the corresponding ID signal. As the environment changes due to human occupancy and motion, the light reflects differently from the environment, which in turn results in different properties in the reflected light signal detected by the photosensor(s). In some cases, each luminaire 100 is further configured to determine, based on the sensed reflected light profile, the occupancy state of the location in the environment corresponding to that reflected light. In other cases, data representing the sensed reflected light profile is passed along with the identified source ID to computing device 200, or to a master luminaire 100, or both, and the occupancy state determination is carried out by device 200 and/or master luminaire 100. In still other embodiments, data representing both the source ID and the detected sensed reflected light profile is passed along to computing device 200, or to a master luminaire 100, or both, and the both the source ID and occupancy state determinations are carried out by device 200 and/or master luminaire 100.

According to some embodiments, computing device 200 is configured to process sensor data from a luminaire 100, determine occupancy states for each monitored location within the environment based on the received sensor data, and maintain a database of current occupancy states for each such location. As occupancy states change from one location to another, tracking determination can also be made. For instance, entrance of an occupant can be initially detected based on changes in reflected light profile near an entrance to the environment. Then, motion of the occupant can be tracked as the initial location is vacated and an adjacent second location becomes occupied, followed by the second location being vacated and an adjacent third location becomes occupied, and so on. Each one of these movements by the occupant can be sensed based on respective changes in the light profile corresponding to the initial, second, and third locations.

To these ends, computing device 200 can be any of a wide range of computing platforms, mobile or otherwise. For example, in accordance with some embodiments, computing device 200 can be, in part or in whole: desktop computer; a laptop/notebook computer; a tablet computer; a smartphone; or a personal digital assistant (PDA). Other suitable configurations for computing device 200 will depend on a given application and will be apparent in light of this disclosure. Computing device 200 may include memory, at least one processor, and a communication module. Likewise, server 300 (if present) may be implemented with standard server hardware and software. In any such cases, computing device 200 and/or server 300 can be programmed or otherwise configured to carry out one or more processes as variously provided herein, according to various embodiments.

The communication networks between server 300 and computing device 200, as well as between the computing device 200 and luminaires 100, can be any suitable public and/or private communication networks. For instance, the network between server 300 and computing device 200 may be a private local area network (LAN) operatively coupled to a wide area network (WAN), such as the Internet. In some cases, the network between the computing device 200 and luminaires 100 may include a wireless local area network (WLAN) (e.g., Wi-Fi wireless data communication technologies). In some instances, the local area network may include Bluetooth wireless data communication technologies. In some cases, computing device 200 may be configured to receive data from server 300, for example, which serves to supplement LCom data received by computing device 200 from a given LCom-enabled luminaire 100. In some instances, computing device 200 may be configured to receive data (e.g., such as position, ID, and/or other data pertaining to a given LCom-enabled luminaire 100) from server 300 that facilitates indoor navigation via one or more LCom-enabled luminaires 100. In some cases, computing device 200 and/or server 300 may include or otherwise have access to one or more databases, such as a database including reflection profiles for each location within an environment being monitored. In one such case, each location is associated with an initial reflection profile or baseline value (or set of values, as the case may be) representing that location in its unoccupied state with respect to a specific light source, and a current reflection profile or baseline value (or set of values, as the case may be) representing that location in its current state (which may be occupied or unoccupied) with respect to that specific light source. The database can be indexed, for instance, by source ID. Numerous database configurations will be apparent in light of this disclosure.

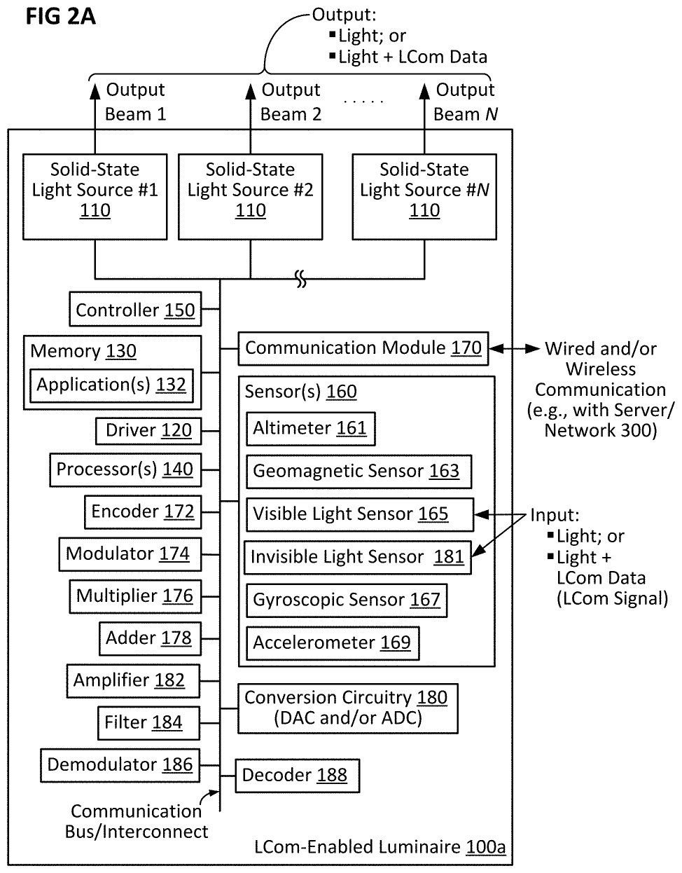

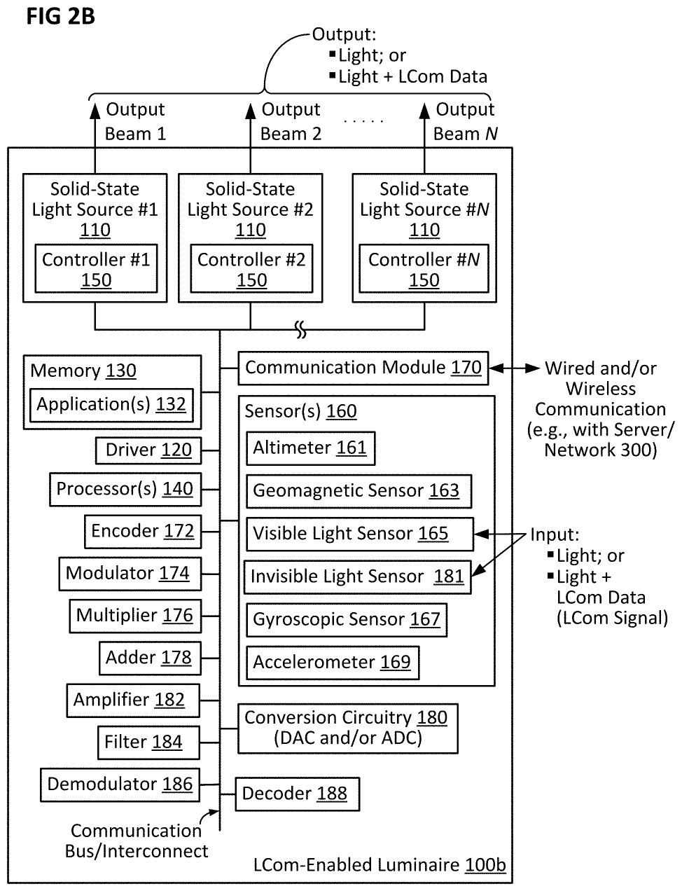

FIG. 2A is a block diagram illustrating an LCom-enabled luminaire 100a configured in accordance with an embodiment of the present disclosure. FIG. 2B is a block diagram illustrating an LCom-enabled luminaire 100b configured in accordance with another embodiment of the present disclosure. For consistency and ease of understanding of the present disclosure, LCom-enabled luminaires 100a and 100b hereinafter may be collectively referred to generally as an LCom-enabled luminaire 100, except where separately referenced.

As can be seen, a given LCom-enabled luminaire 100 may include one or more solid-state light sources 110, in accordance with some embodiments. The quantity, density, and arrangement of solid-state light sources 110 utilized in a given LCom-enabled luminaire 100 may be customized, as desired for a given target application or end-use. A given solid-state light source 110 may include one or more solid-state emitters, which may be any of a wide range of semiconductor light source devices, such as, for example: (1) a light-emitting diode (LED); (2) an organic light-emitting diode (OLED); (3) a polymer light-emitting diode (PLED); and/or (4) a combination of any one or more thereof. A given solid-state emitter may be configured to emit electromagnetic radiation (e.g., light), for example, from the visible spectral band and/or other portions of the electromagnetic spectrum not limited to the infrared (IR) spectral band and/or the ultraviolet (UV) spectral band, as desired for a given target application or end-use. In some embodiments, a given solid-state emitter may be configured for emissions of a single correlated color temperature (CCT) (e.g., a white light-emitting semiconductor light source). In some other embodiments, however, a given solid-state emitter may be configured for color-tunable emissions. For instance, in some cases, a given solid-state emitter may be a multi-color (e.g., bi-color, tri-color, etc.) semiconductor light source configured for a combination of emissions, such as: (1) red-green-blue (RGB); (2) red-green-blue-yellow (RGBY); (3) red-green-blue-white (RGBW); (4) dual-white; and/or (5) a combination of any one or more thereof. In some cases, a given solid-state emitter may be configured as a high-brightness semiconductor light source. In some embodiments, a given solid-state emitter may be provided with a combination of any one or more of the aforementioned example emissions capabilities. In any case, a given solid-state emitter can be packaged or non-packaged, as desired, and in some cases may be populated on a printed circuit board (PCB) or other suitable substrate, as will be apparent in light of this disclosure. In some cases, power and/or control connections for a given solid-state emitter may be routed from a given PCB to a driver 120 (discussed below) and/or other devices/componentry, as desired. Other suitable configurations for the one or more solid-state emitters of a given solid-state light source 110 will depend on a given application and will be apparent in light of this disclosure.

A given solid-state light source 110 also may include one or more optics optically coupled with its one or more solid-state emitters. In accordance with some embodiments, the optic(s) of a given solid-state light source 110 may be configured to transmit the one or more wavelengths of interest of the light (e.g., visible, UV, IR, etc.) emitted by solid-state emitter(s) optically coupled therewith. In addition, or alternatively, the optic(s) may be configured to directionally transmit (e.g., focus and/or collimate) light from a given solid-state light source 110, so as to allow that light source 110 to illuminate a specific location within the environment. To that end, the optic(s) may include an optical structure (e.g., a window, lens, dome, etc.) formed from any of a wide range of optical materials, such as, for example: a polymer, such as poly(methyl methacrylate) (PMMA) or polycarbonate; a ceramic, such as sapphire (Al₂O₃) or yttrium aluminum garnet (YAG); a glass; and/or a combination of any one or more thereof. In some cases, the optic(s) of a given solid-state light source 110 may be formed from a single (e.g., monolithic) piece of optical material to provide a single, continuous optical structure. In other cases, the optic(s) may be formed from multiple pieces of optical material to provide a multi-piece optical structure. In some cases, the optic(s) may include optical features, such as, for example: an anti-reflective (AR) coating; a reflector; a diffuser; a polarizer; a brightness enhancer; a phosphor material (e.g., which converts light received thereby to light of a different wavelength); and/or a combination of any one or more thereof. Other suitable types, optical transmission characteristics, and configurations for the optic(s) will depend on a given application as will be appreciated.

In accordance with some embodiments, the one or more solid-state light sources 110 of a given LCom-enabled luminaire 100 may be electronically coupled with a driver 120. In some cases, driver 120 may be an electronic driver (e.g., single-channel; multi-channel) configured, for example, for use in controlling one or more solid-state emitters of a given solid-state light source 110. For instance, in some embodiments, driver 120 may be configured to control the on/off state, dimming level, color of emissions, correlated color temperature (CCT), and/or color saturation of a given solid-state emitter (or grouping of emitters). To such ends, driver 120 may utilize any of a wide range of driving techniques, including, for example: a pulse-width modulation (PWM) dimming protocol; a current dimming protocol; a triode for alternating current (TRIAC) dimming protocol; a constant current reduction (CCR) dimming protocol; a pulse-frequency modulation (PFM) dimming protocol; a pulse-code modulation (PCM) dimming protocol; a line voltage (mains) dimming protocol (e.g., dimmer is connected before input of driver 120 to adjust AC voltage to driver 120); and/or a combination of any one or more thereof. Other suitable configurations for driver 120 and lighting control/driving techniques will depend on a given application and will be apparent.

A given solid-state light source 110 also may include or otherwise be operatively coupled with other circuitry/componentry which may be used, for example, in solid-state lighting. For instance, a given solid-state light source 110 (and/or host LCom-enabled luminaire 100) may be configured to host or otherwise be operatively coupled with any of a wide range of electronic components, such as: power conversion circuitry (e.g., electrical ballast circuitry to convert an AC signal into a DC signal at a desired current and voltage to power a given solid-state light source 110); constant current/voltage driver componentry; transmitter and/or receiver (e.g., transceiver) componentry; and/or local processing componentry. When included, such componentry may be mounted, for example, on one or more driver 120 boards, in accordance with some embodiments.

As can be seen from FIGS. 2A-2B, LCom-enabled luminaire 100 may include memory 130 and one or more processors 140. Memory 130 can be of any suitable type (e.g., RAM and/or ROM, flash memory, disk-drive, or other machine-readable memory) and size, and may be implemented with volatile memory, non-volatile memory, or a combination thereof. Processor 140 may be any suitable processor (e.g., microprocessor or CPU or custom-built processor), and in some embodiments is programmed or otherwise configured, for example, to perform operations associated with a given host LCom-enabled luminaire 100 and one or more of the modules thereof (e.g., within memory 130 or elsewhere). In some cases, memory 130 may be configured to be utilized, for example, for processor workspace and/or an extension of on-board processor cache (e.g., for one or more processors 140) and/or to store media, programs, applications, and/or content on a host LCom-enabled luminaire 100 on a temporary or permanent basis.

The one or more modules stored in memory 130 can be accessed and executed, for example, by the one or more processors 140. In accordance with some embodiments, a given module of memory 130 can be implemented in any suitable standard and/or custom/proprietary programming language, such as, for example: C; C++; objective C; JavaScript; and/or any other suitable custom or proprietary instruction sets. The modules encoded in memory 130, when executed by one or more processors 140, cause corresponding functionality to be carried out, in part or in whole. Other embodiments may not have a process-memory-software arrangement per se; for instance, some example embodiments can be implemented with all hardware such as gate-level logic or an application-specific integrated circuit (ASIC) or chip set or other such purpose-built logic. Some embodiments can be implemented with a microcontroller having input/output capability (e.g., inputs for receiving user inputs; outputs for directing other components) and a number of embedded routines for carrying out the device functionality. In a more general sense, the functionality provided by the execution of software modules in memory 130 (e.g., applications 132) by one or more processors 140 can be implemented in hardware, software, and/or firmware, as will be appreciated.

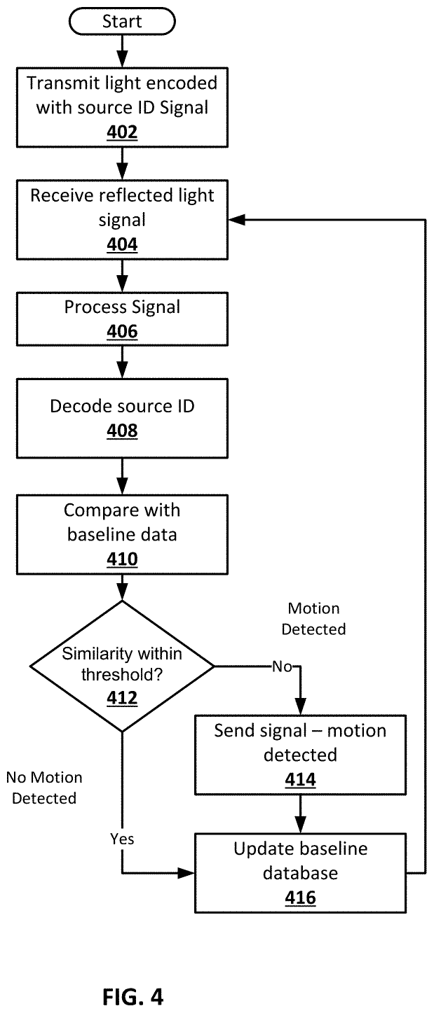

In accordance with the embodiments shown, memory 130 has stored therein (or otherwise has access to) one or more applications 132. In some instances, a given LCom-enabled luminaire 100 may be configured to receive input, for example, via one or more applications 132 (e.g., a lighting pattern or other lighting control data, as well as photosensor data or data representative of photosensor data, baseline light reflection profiles, or any other data usable for light-based occupancy determinations as variously provided herein). In one example embodiment, a software routine that embodies the method provided in FIG. 4 may be included in the applications 132, and executed by one or more processors 140. Other suitable modules, applications, and data which may be stored in memory 130 (or may be otherwise accessible to a given LCom-enabled luminaire 100) will depend on a given application and will be apparent in light of this disclosure.

In accordance with some embodiments, the one or more solid-state light sources 110 can be electronically controlled, for example, to output light and/or light encoded with LCom data (e.g., an LCom signal). To that end, a given LCom-enabled luminaire 100 may include or otherwise be communicatively coupled with one or more controllers 150, in accordance with some embodiments. In some such embodiments, such as that illustrated in FIG. 2A, a controller 150 may be hosted by a given LCom-enabled luminaire 100 and operatively coupled (e.g., via a communication bus/interconnect) with the one or more solid-state light sources 110 (1-N) of that LCom-enabled luminaire 100. In this example case, controller 150 may output a control signal to any one or more of the solid-state light sources 110 and may do so, for example, based on input received from a given local source (e.g., such as an application 132) and/or remote source (e.g., such as server 300). As a result, a given luminaire 100 may be controlled in such a manner as to output any number of output beams (1-N), which may include light and/or LCom data (e.g., an LCom signal).

In other embodiments, such as that illustrated in FIG. 2B, a controller 150 may be hosted, in part or in whole, by a given solid-state light source 110 of a given LCom-enabled luminaire 100 and operatively coupled (e.g., via a communication bus/interconnect) with the one or more solid-state light sources 110. If a given luminaire 100 includes a plurality of such solid-state light sources 110 hosting their own controllers 150, then each such controller 150 may be considered, in a sense, a mini-controller, providing that luminaire 100 with a distributed controller 150. In some embodiments, controller 150 may be populated, for example, on one or more PCBs of the host light source 110. In this example case, controller 150 may output a control signal to an associated solid-state light source 110 of luminaire 100 and may do so, for example, based on input received from a given local source and/or remote source as previously explained with respect to FIG. 2A. As a result, luminaire 110 may be controlled in such a manner as to output any number of output beams (1-N), which may include light and/or LCom data (e.g., a source identifying signal).

In accordance with some embodiments, a given controller 150 may host one or more lighting control modules and can be programmed or otherwise configured to output one or more control signals, for example, to adjust the operation of the solid-state emitter(s) of a given light source 110. For example, in some cases, a given controller 150 may be configured to output a control signal to control whether the light beam of a given solid-state emitter is on/off. In some instances, a given controller 150 may be configured to output a lighting control signal that causes a unique source ID to be encoded into the light emitted by a given solid-state emitter, by modulating that light. Likewise, a given controller 150 may be configured to output a control signal to control the intensity/brightness (e.g., dimming; brightening) and/or the color (e.g., mixing; tuning) of the light emitted by a given solid-state emitter. Note that, in some cases, if a given solid-state light source 110 includes two or more solid-state emitters configured to emit light having different wavelengths, the control signal(s) provided may be used to adjust the relative brightness of the different solid-state emitters to change the mixed color output by that solid-state light source 110. In some embodiments, controller 150 may be configured to output a control signal to encoder 172 (discussed below) to facilitate encoding of LCom data, including a source identifying signal, for transmission by a given LCom-enabled luminaire 100. In some embodiments, controller 150 may be configured to output a control signal to modulator 174 (discussed below) to facilitate modulation of an LCom signal for transmission by a given luminaire 100. Other suitable configurations and control signal output for a given controller 150 of a given LCom-enabled luminaire 100 will depend on a given application and will be apparent in light of this disclosure.

In accordance with some embodiments, a given LCom-enabled luminaire 100 may include one or more encoders 172. In some such embodiments, encoder 172 is configured, for example, to encode LCom data in preparation for transmission into the environment and/or to another LCom-enabled luminaire 100. To that end, encoder 172 may be provided with any suitable configuration suitable for encoding light. Alternatively, or in addition, a given LCom-enabled luminaire 100 may include one or more modulators 174. In some embodiments, modulator 174 is configured, for example, to modulate an LCom signal in preparation for transmission into the environment and/or to another LCom-enabled luminaire 100. The modulator 174 may be a single-channel or multi-channel electronic driver (e.g., driver 120) configured, for example, for use in controlling the output of the one or more solid-state emitters of a given solid-state light source 110. In some embodiments, modulator 174 may be configured to control the on/off state, dimming level, color of emissions, correlated color temperature (CCT), and/or color saturation of a given solid-state emitter (or grouping of emitters). To such ends, modulator 174 may utilize any of a wide range of driving techniques, such as those previously described with respect to driver 120. Other suitable configurations for modulator 174 will depend on a given application and will be apparent in light of this disclosure. Note that encoding and modulating may be used for similar reasons and are thus interchangeable, and both are not necessary in all embodiments, while other embodiments may use both. For instance, a light source ID can be encoded, and lighting control parameters may be modulated, or vice-versa. Alternatively, just the source ID may be encoded, or modulated, if no LCom-based light control parameters are needed for a given application. Numerous variations will be apparent in light of this disclosure.

In accordance with some embodiments, a given LCom-enabled luminaire 100 may include one or more multipliers 176. Multiplier 176 may be implemented in a standard fashion, and in some example embodiments is configured to combine an input received from an upstream modulator 174 with an input received from a visible light sensor 165 or invisible light sensor 181 (discussed below). In a more general sense, multiplier 176 is configured to increase and/or decrease the amplitude of a signal passing therethrough, depending on the signals input to multiplier 176. Note that multiplier 176 may have any number of inputs. Numerous configurations and uses for multiplier 176 will be apparent.

In accordance with some embodiments, a given LCom-enabled luminaire 100 may include one or more adders 178. Adder 178 may be implemented in a standard fashion, and in some example embodiments is configured to combine an input received from an upstream multiplier 176 with a DC level input. In a more general sense, adder 178 is configured to increase and/or decrease the amplitude of a signal passing therethrough, depending on the signals input to adder 178. Note that adder 178 may have any number of inputs. Numerous configurations and uses for adder 178 will be apparent.

In accordance with some embodiments, a given LCom-enabled luminaire 100 may include conversion circuitry 180, which may include one or more digital-to-analog converters (DAC) and/or analog-to-digital converters (ADC). As is generally known, a DAC is configured to convert a digital signal into an analog signal, and an ADC is configured to convert an analog signal into a digital signal. The resulting analog and/or digital signals can be applied in any number of useful ways depending on the nature of the signal being converted. For instance, in some example embodiments, the resulting signal generated by conversion circuitry 180 is an analog version of a digital light control signal. The digital light control signal may be, for instance, generated by one or more of the driver 120, encoder 172, modulator 174, multiplier 176, and/or adder 178. In such cases, the resulting analog lighting control signal generated by the digital-to-analog conversion can be applied to a given solid-state light source 110 of the host LCom-enabled luminaire 100, thereby causing a desired lighting output that may include, for example, visible light to illuminate a given location as well as one or more LCom signals (e.g., light signal encoded with source ID). In other cases, the resulting signal generated by conversion circuitry 180 is a digital version of an analog sensor detection signal. The analog sensor detection signal may be, for instance, generated by the visible light sensor 165 or invisible light sensor 181. In such cases, the resulting digital sensor detection signal generated by the analog-to-digital conversion can be processed as needed, if any (e.g., filtered), and used in an occupancy state determination, as variously provided herein. As will be further appreciated in light of this disclosure, input signals provided to conversion circuitry 180 may also be pre-processed as needed (if any) (e.g., amplified and/or filtered), prior to desired conversion from one domain to the other.

In accordance with some embodiments, a given LCom-enabled luminaire 100 may include one or more amplifiers 182. As is generally known, an amplifier is configured to amplify (or attenuate as the case may be) a given input signal based on the forward gain of that amplifier, which can be tailored to a given application or purpose. For instance, in some example embodiments, the detection signals generated by any of the sensors 160, such as the visible light sensor 165 and/or invisible light sensor 181. In such cases, the amplification (or attenuation) provided by amplifier 182 prepares the detection signals for further processing by setting the magnitude of those signals to a suitable range.

In accordance with some embodiments, a given LCom-enabled luminaire 100 may include one or more filters 184. As is generally known, a filter can be configured to filter out undesired components of a given signal or spectrum, and may be implemented in the analog or digital domains with any number of suitable configurations (e.g., low-pass filters, high-pass filters, bandpass filters, notch filters, bi-modal filters, multi-modal filters, comb filters, FFT filters, etc). The filtered (removed or diminished) component(s) may include, for instance, low frequency noise, high-frequency noise, and/or any other undesired signal frequencies. For instance, in some example embodiments, the reflected signals received by visible light sensor 165 and/or invisible light sensor 181 can be filtered with lens-based filters to eliminate undesired ranges of light. Likewise, the detection signals generated by visible light sensor 165 and/or invisible light sensor 181 can be filtered with circuit-based filters (analog and/or digital) to eliminate noise signal or otherwise improve signal-to-noise ratio.

In accordance with some embodiments, a given LCom-enabled luminaire 100 may include one or more demodulators 186. As is generally known, a demodulator is configured to demodulate a modulated signal generated in accordance with a modulation scheme implemented by an upstream modulator. According to some embodiments, a modulated LCom signal generated by a modulator 174 of a transmitting luminaire 100 is received by visible light sensor 165 and/or invisible light sensor 181, and eventually passed to demodulator 186 (e.g., directly passed, or passed after analog-to-digital conversion, amplification, and/or filtering). In such cases, demodulator 186 is configured to demodulate that LCom signal to obtain the source ID of the transmitting luminaire 100. In addition, or alternatively, demodulator 186 may be configured to interpret the on/off state, dimming level, color of emissions, correlated color temperature (CCT), and/or color saturation of a received signal. To such ends, demodulator 186 may interpret any of a wide range of modulating techniques, including those modulation schemes previously described with respect to driver 120. Numerous modulation/demodulation schemes can be used as will be appreciated in light of this disclosure.

In accordance with some embodiments, a given LCom-enabled luminaire 100 may include one or more decoders 188. As is generally known, a decoder is configured to decode an encoded signal generated in accordance with an encoding scheme implemented by an upstream encoder. According to some embodiments, an encoded LCom signal generated by an encoder 172 of a transmitting luminaire 100 is received by visible light sensor 165 and/or invisible light sensor 181, and eventually passed to decoder 188 (e.g., directly passed, or passed after analog-to-digital conversion, amplification, and/or filtering). In such cases, decoder 188 is configured to decode that LCom signal to obtain the source ID of the transmitting luminaire 100. In addition, or alternatively, decoder 188 may be configured to interpret the on/off state, dimming level, color of emissions, correlated color temperature (CCT), and/or color saturation of a received signal. To such ends, decoder 188 may interpret any of a wide range of encoding techniques, including those previously described with respect to driver 120. Recall that modulating and encoding (along with demodulating and decoding) may be used interchangeably herein. For instance, digital data can be encoded by modulating carrier amplitude, carrier frequency, or carrier phase, or some combination of carrier signal parameters. Numerous encoding/decoding schemes can be used as will be apparent in light of this disclosure.

In accordance with some embodiments, a given LCom-enabled luminaire 100 may include one or more sensors 160. In some embodiments, a given LCom-enabled luminaire 100 may include an altimeter 161. When included, altimeter 161 may be implemented in a standard fashion, and in some example embodiments is configured to aid in determining the altitude of a host LCom-enabled luminaire 100 with respect to a given fixed level (e.g., a floor, a wall, the ground, or other surface). In some embodiments, a given LCom-enabled luminaire 100 may include a geomagnetic sensor 163. When included, geomagnetic sensor 163 may be implemented in a standard fashion, and in some example embodiments is configured to determine the orientation and/or movement of a host LCom-enabled luminaire 100 relative to a geomagnetic pole (e.g., geomagnetic north) or other desired heading, which may be customized as desired for a given target application or end-use.

In some embodiments, a given LCom-enabled luminaire 100 may include one or more visible light sensors 165 and/or invisible light sensors 181. Such sensors may be implemented in a standard fashion, and in some example embodiments are configured to detect and measure visible (165) and/or invisible (181) light levels in the surrounding environment of the host LCom-enabled luminaire 100, including encoded light reflected from that environment. As will be appreciated in light of this disclosure, occupancy of a given location within the environment can cause changes in the reflected light received from that location by sensor(s) 165 and/or 181. Thus, the output of sensor(s) 165 and/or 181 can be used in making occupancy determinations for that location. For instance, in some such cases, sensor(s) 165 and/or 181 is configured to, among other things, sense changes in visible light reflections and to output a detection signal for further processing such as, for example, amplification by multiplier 176 or amplifier 182, filtering by filter 184, and/or conversion by conversion circuitry 180. The sensor data may be processed local to the luminaire 100, and/or by a remote server or computing device that is communicatively coupled with the luminaire 100. In some embodiments, processing performed at the luminaire 100 includes any needed filtering and amplification, along with comparing the sensor signal with a baseline signal to make a determination as to whether the occupancy state of that location has changed. The comparing can be done by, for example, a processor 140. In other embodiments, the comparing can be done by computing device 200 or server 300. Other computing schemes will be apparent.

In some embodiments, a given LCom-enabled luminaire 100 may include a gyroscopic sensor 167. When included, gyroscopic sensor 167 may be implemented in a standard fashion, and in some example embodiments may be configured to determine the orientation (e.g., roll, pitch, and/or yaw) of the host LCom-enabled luminaire 100. In some embodiments, a given LCom-enabled luminaire 100 may include an accelerometer 169. When included, accelerometer 169 may be implemented in a standard fashion, and in some example embodiments may be configured to detect motion of the host LCom-enabled luminaire 100.

In any case, a given sensor 160 of a given host LCom-enabled luminaire 100 may include mechanical and/or solid-state componentry, as desired for a given target application or end-use. Also, it should be noted that the present disclosure is not so limited only to these example sensors 160, as additional and/or different sensors 160 may be provided, as desired for a given target application or end-use, in accordance with some other embodiments. Numerous configurations will be apparent in light of this disclosure.

In accordance with some embodiments, a given LCom-enabled luminaire 100 may include a communication module 170, which may be configured for wired (e.g., Universal Serial Bus or USB, Ethernet, FireWire, etc.) and/or wireless (e.g., Wi-Fi, Bluetooth, etc.) communication, as desired. In accordance with some embodiments, communication module 170 may be configured to communicate locally and/or remotely utilizing any of a wide range of wired and/or wireless communications protocols, including, for example: a digital multiplexer (DMX) interface protocol; a Wi-Fi protocol (e.g., IEEE 802.11), an radio frequency (RF) communication protocol; a Bluetooth protocol; a digital addressable lighting interface (DALI) protocol; a ZigBee protocol; and/or a combination of any one or more thereof. It should be noted, however, that the present disclosure is not so limited to only these example communications protocols, as in a more general sense, and in accordance with some embodiments, any suitable communications protocol, wired and/or wireless, standard and/or custom/proprietary, may be utilized by communication module 170, as desired for a given target application or end-use. In some instances, communication module 170 may be configured to facilitate inter-luminaire communication between LCom-enabled luminaires 100. To that end, communication module 170 may be configured to use any suitable wired and/or wireless transmission technologies (e.g., radio frequency, or RF, transmission; infrared, or IR, light modulation; etc.), as desired for a given target application or end-use. Other suitable configurations for communication module 170 will depend on a given application and will be apparent in light of this disclosure.

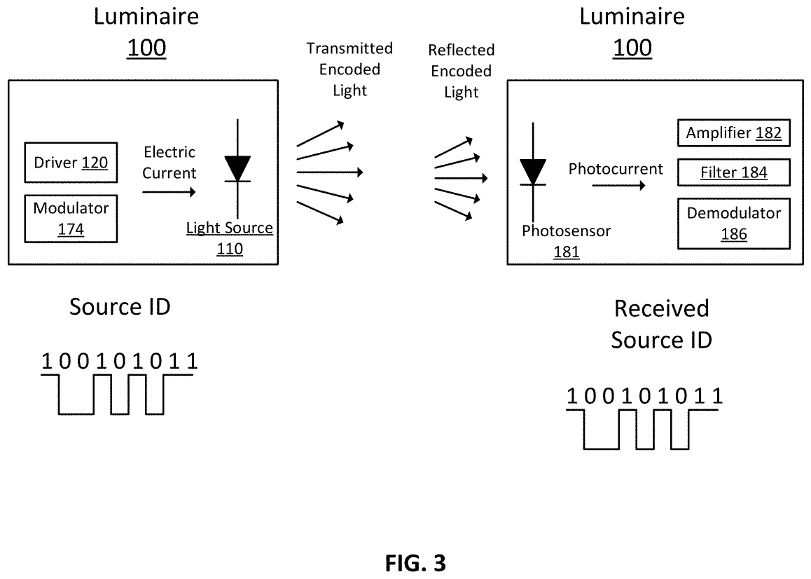

FIG. 3 illustrates an example transmission and receipt of light encoded with a source ID as may be transmitted and received by an LCom-enabled luminaire 100, in accordance with an embodiment of the present disclosure. As can be seen, the transmitting luminaire 100 (depicted on the left of FIG. 3) is using a modulator 174 to encode the source ID (100101011) into the drive signal generated by driver 120, which in turn causes light source 110 to emit light encoded with the source ID. As can be further seen, the receiving luminaire 100 (depicted on the right of FIG. 3) is using a photosensor 181 to detect reflected instances of the encoded light emitted by the transmitting luminaire. In this example embodiment, the detection signals are amplified by amplifier 182, filtered by filter 184, and demodulated by demodulator 186 so as to decode and the source ID (100101011) from the received encoded light reflections. In other embodiments, note that the modulating or encoding function provided by component 174 (and/or 172, as the case may be) may be integrated directly into the driver 120 (e.g., programmable drive signal). Likewise, the photosensor 181 (and/or sensor 165, as the case may be) may be directly integrated with the signal processing circuitry such as 182, 184, and 186 (and/or 188) in other embodiments. Numerous such variations will be apparent. The reflected light signal reflects off a portion of the environment and/or one or more occupants within the path of the transmitted and/or reflected light.

Note that the pulsing of the drive signal is sufficient to encode or otherwise provide logical 1's (e.g., light source 110 on) and 0's (e.g., light source 110 off) to represent the source ID within the emitted light, but is also sufficiently fast so as to still cause the light source 110 to be driven in a manner in which the light output appears to be constant to the average human eye (i.e., the occupants will not perceive flickering of light source 110). In still other embodiments, the encoded light is invisible light, and therefore there is no human-perceptible flickering. Further note that the number of bits representing the source ID can vary, depending on the number of light sources 110 to be uniquely represented. For instance, the source ID in this example embodiment includes 9 bits, which provides up to 512 unique source IDs, and therefore can be used to identify 512 unique light sources 110 or luminaires 100. Further note that the receiving luminaire may include a lightguide as previously explained, to tailor the FOV associated with the sensors 165 and/or 181.

Methodology

FIG. 4 illustrates a method for human detection and motion tracking, in accordance with an embodiment of the present disclosure. As previously explained, the method may be carried out directly in a given luminaire, or may be distributed between a luminaire and a computing system local to but distinct from the luminaire and/or a computing system remote from the luminaires. The methodology may be embodied, for instance, in one or more non-transitory machine readable mediums encoded with instructions that when executed by one or more processors cause a process to be carried out for human detection and motion tracking. Numerous variations will be apparent.

As can be seen, the method includes transmitting light encoded with a source-identifying (ID) signal into the area in block 402. Encoding the source ID may be performed using any number of encoding and/or modulating techniques as previously explained. In some embodiments, the encoded light is visible light so as to also provide illumination to the area, but other embodiments may invisible light as previously explained. The transmitting may be carried out by multiple light sources, each having a unique source ID and covering a given location in the area being monitored, so that reflected instances of any such light can be attributed to a specific light source. Recall that overlap between the light sources is ok, and in some embodiments used to facilitate motion tracking.

The method continues with receiving the encoded light reflected back from the area, via a light sensor (visible and/or invisible light sensors, as the case may be), thereby generating a detection signal in block 404. As explained herein, the light reflected from the area being monitored changes based on physical changes within the area, such as the placement or movement of furniture or other objects, and the presence and movement of humans. Further recall that in some embodiments a lightguide is used to tailor the FOV of the sensor, so the light-guided sensor can be associated with a specific location or sub-area with the area. Thus, activity within that particular location can be monitored for purposes of tracking movement into and out of that location. To this end, at any given time, a given monitored location can have the status of occupied or unoccupied, as determined by changes in the detection signals. In some embodiments, these statuses can be stored, for example, in a database that is indexed by source ID or location, although any number of storage schemes can be used. As will be explained in turn, such a database can be used in efficiently assessing occupancy as well as movement of occupants from one location to another with the area.

The method continues with processing the detection signal representing the reflected light signal in block 406. The processing can vary from one embodiment to the next and depends on factors such as the light sensor being used and the quality of the detection signal, but in some cases includes amplifying and filtering the detection signal as needed, and measuring or otherwise extracting various parameters of the detection signal so as to provide detection signal data that can be used in assessing the occupancy state of the corresponding location. In some embodiments, this assessment includes comparing the detection signal data to current baseline data, as will be explained in turn. The detection signal data may include, for instance, one or more properties of the detection signal such as signal amplitude, frequency, and modulation and/or encoding scheme.

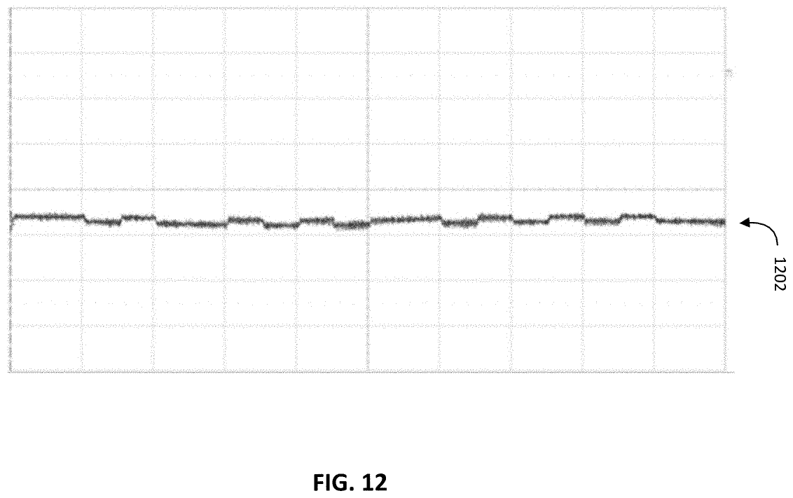

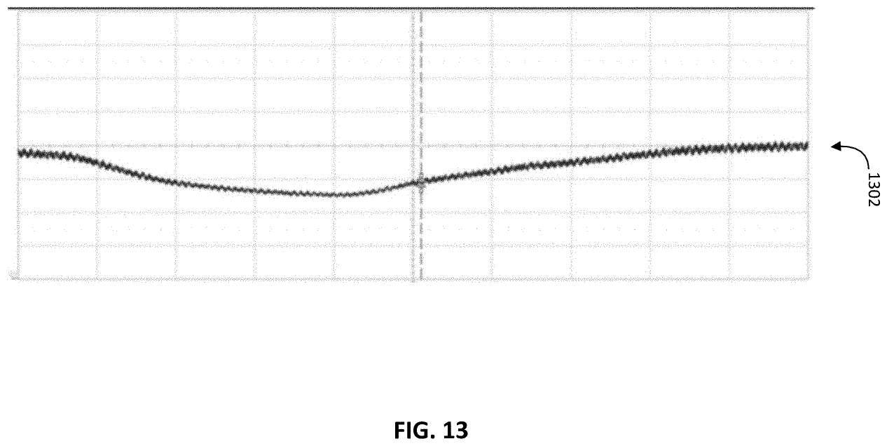

The method continues with decoding or otherwise extracting the source ID from the detection signal in block 408. The source ID can be used to associate the reflected light to a particular light source at a known location within the area being monitored. Decoding may occur locally (e.g., via processor 140 or computing device 200) or remotely (e.g., via server 300). In one embodiment, the light source includes an LED emitting modulated visible light, although other light sources and spectrums of light can be used as will be appreciated. In some such embodiments, the modulation of the LED can be accomplished by applying digital signals (logical 1's and 0's) to a tunable constant current power supply, thereby causing the light source to correspondingly turn on (e.g., logical 1) and off (e.g., logical 0) at a relatively high rate such that the light source appears to be constantly on or otherwise flicker-free to the human eye (such as shown in the example depicted in FIG. 3). In any case, such modulation/encoding is known or otherwise detected and the logical source ID code can be determined. Any number of encoding/modulating and complementary decoding/demodulating schemes can be used. In one example use case, the photodiode or other photosensor is pointed to the floor of the area and receives the light signal reflected off of the floor. Numerous such use cases will be appreciated in light of this disclosure. In any such cases, note that the detection signal corresponding to the captured signal can be viewed on an oscilloscope in the time domain to further appreciate how source ID can be detected (based on modulation/encoding scheme used by transmitter), as well as a change in occupancy (such as shown via the comparison of depicted in FIGS. 12 and 13, which will be discussed in turn).

The method continues with comparing the detection signal data with current baseline data in block 410, and determining if the similarity between the detection signal data and the current baseline data is within a threshold (or not) in block 412. As can be further seen, if the determination at indicates a lack of similarity, then the method includes signaling or otherwise indicating a change in occupancy state (movement of a human into or out of that location) in block 414. That signal or indication can be used in a number of ways, such as to trigger a change in lighting and/or environmental controls (e.g., turn lights and AC on or off, depending on occupancy or no occupancy), or cause an alarm to be generated (e.g., intruder alert). In such cases, the method continues with updating the baseline to reflect the new detection signal data in block 417. On the other hand, if the determination indicates similarity between the detection signal data and the current baseline data, then the occupancy state of that location can be inferred to be unchanged and the baseline may be left as is. In other embodiments, however, even though no change in occupancy state (no motion) was detected, the baseline can still be updated in block 416 with the most recent data obtained in block 406. Such is helpful in cases, for instance, where the current occupant is still in the location, but has moved a chair or other object. To this end, updating the baseline data regardless of whether occupancy state has change allows ongoing comparisons to be made (each new reading is relative to the previous reading).

The comparison in block 410 can be achieved in a number of ways, as will be appreciated. In one example embodiment, the comparison includes comparing one or more reflected signal properties (e.g., signal amplitude) with that of the current baseline reflected signal properties. The current baseline reflected signal properties are associated with the source ID, and can be recalled or otherwise accessed using that source ID, according to some embodiments. So, for instance, if the reflected signal amplitude obtained in block 408 is sufficiently different than the current baseline amplitude (based on a minimum threshold amplitude difference), then a change in occupancy state can be inferred within the corresponding location. Note that the compared amplitudes (or other parameters) may each be a set of amplitudes. In such cases, the sets of amplitudes can be represented, for instance, in a vector format to facilitate comparison.

The determination in block 412 may involve any number of methods for determining if there is a sufficient difference between the current signal data and the baseline data. In some embodiments, for instance, this determination includes using calculations involving two data points (e.g., amplitude from block 406 and amplitude indicated in baseline), such as calculating a percent change (e.g., [(X(current data)−X(baseline)]/X(baseline)*100), and comparing it with a change threshold. In other embodiments, a set of comparisons or a vector-based comparison may be utilized.

Human Detection and Tracking Example Use Cases

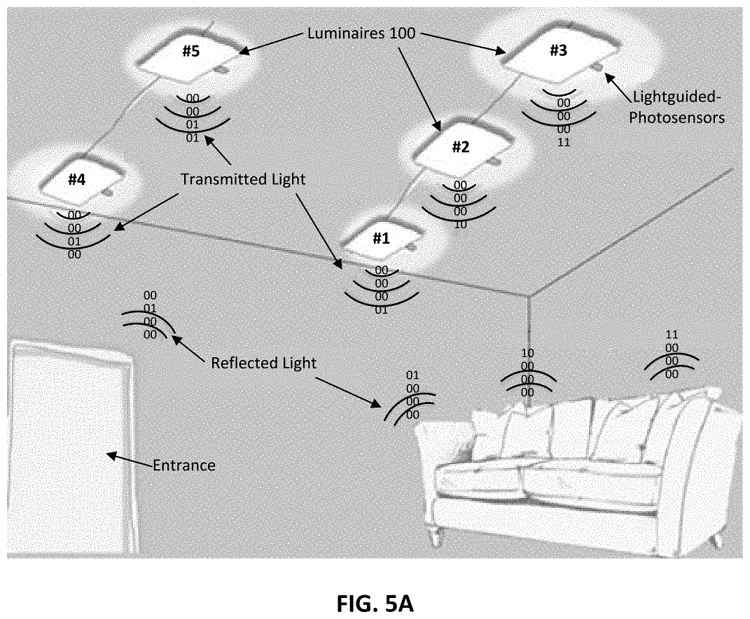

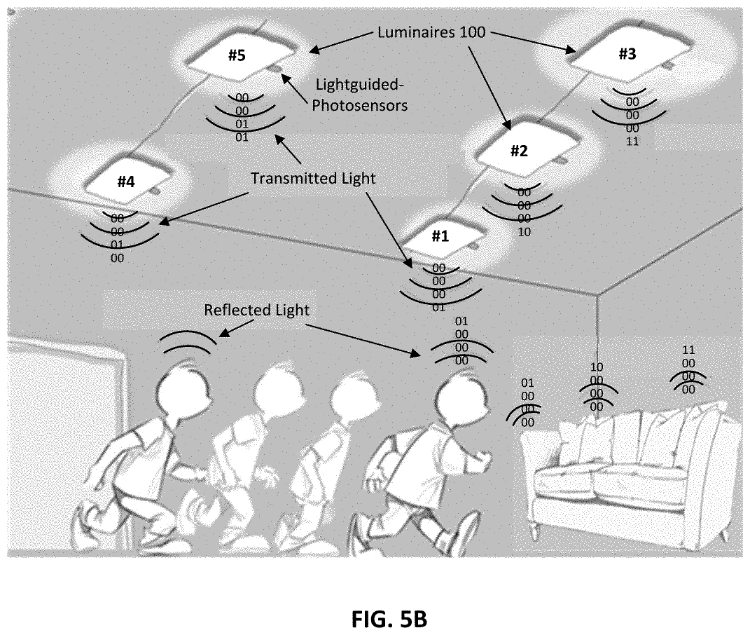

FIGS. 5A and 5B illustrate an example scenario using reflected light to detect human presence and location within an area, in accordance with an embodiment of the present disclosure. In this example, a plurality of luminaires 100 (five of them, labeled #1 through #5) is installed in the ceiling of an area. The luminaires 100 can be executing, for instance, the method of FIG. 4, although other variations and embodiments will be appreciated in light of this disclosure.

Luminaires 100 transmit light into the area. In addition, each luminaire 100 includes a lightguided photosensor (e.g., photodiode with a cone-shaped lightguide that effectively defines the FOV of the photodiode). As can further be seen, the transmitted light is encoded with a source ID. The code is imperceptible to the human eye, but is detected by the photosensors. So, in this example case, luminaire #1 emits light encoded with 000001, luminaire #2 emits light encoded with 000010, luminaire #3 emits light encoded with 000011, luminaire #4 emits light encoded with 000100, and luminaire #5 emits light encoded with 000101. When the room is unoccupied, the transmitted light reflects off of surfaces (e.g., walls, door jams, etc) and objects (e.g., couch) in the area. Note the reflected light remains encoded with the source ID. Although five luminaires are provided in this example, any number of luminaires may be used to illuminate the area, and the illuminated area may have any number of configurations (e.g., cube farm or other office space with hallways, a home, healthcare facility, etc, as will be appreciated). As can be seen in FIG. 5B, as an occupant moves through the area, one or more transmitted light signals reflect off the human as reflected light. Alternatively, the occupant may block light signals, rather than reflect light signals back to the sensor. In either case, the presence of an occupant changes the reflected light sensed by the photosensors.

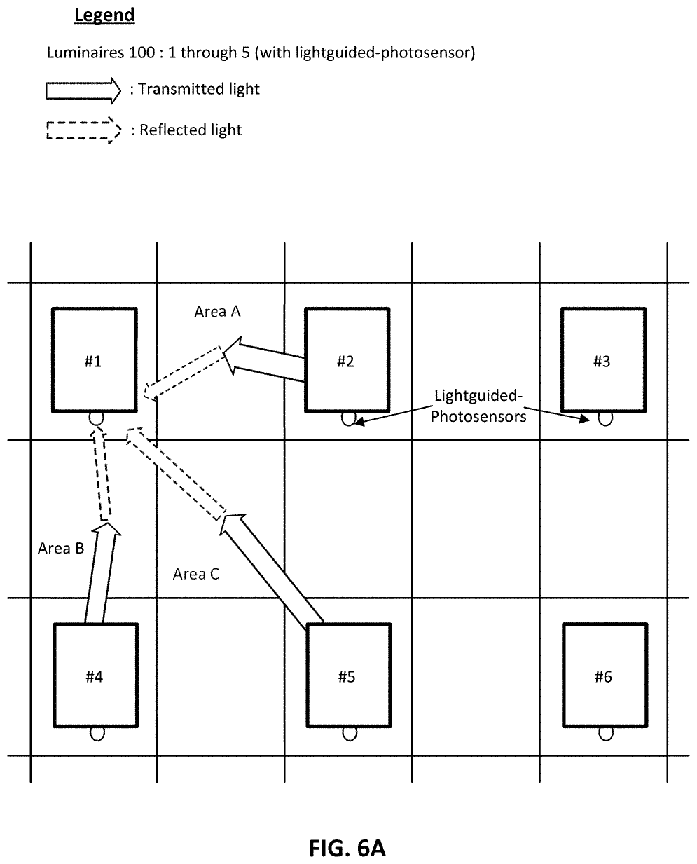

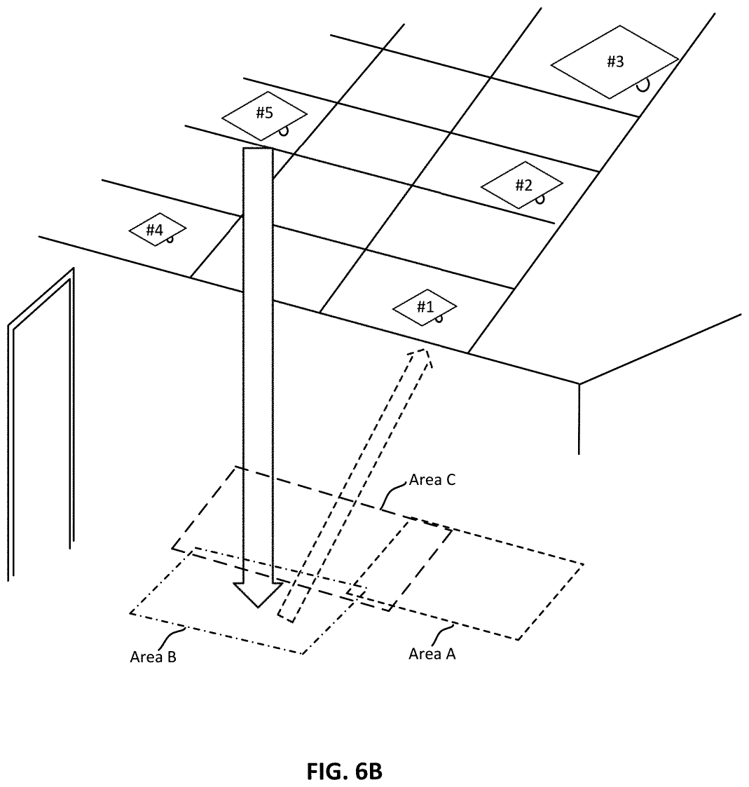

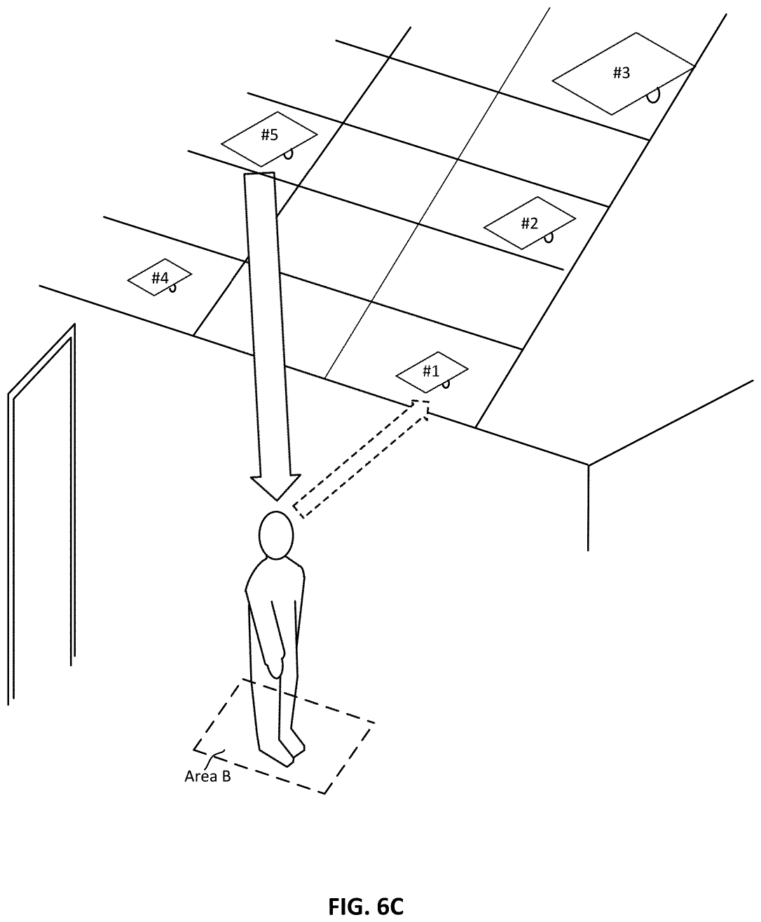

FIG. 6A illustrates a top-down view of an example human detection and tracking system using reflected light, in accordance with an embodiment of the present disclosure. As can be seen, the system includes a plurality of luminaires (six of them, labeled #1 through #6) installed in the ceiling of a space. The space is divided into areas, such as locations A, B, C, and so on. The luminaires emit light encoded with their respective ID signals into the space. Light from the luminaires may be transmitted throughout the space or may be restricted to certain areas within the space. For example, luminaire #4 transmits light into area B, and possibly other areas, which is fine. As can be further seen, transmitted light from luminaire #4 reflects off the environment within area B, and at least some of that reflected light is received at the photosensor of luminaire #1. In some such embodiments, the lightguide associated with the photosensor of luminaire #1 is shaped or otherwise arranged to pass only light reflected from area B, and to block light from other areas. For instance, with such a FOV, the photosensor of luminaire #1 does not sense light reflected off area A or area C. In a more general sense, luminaire can be configured to selectively sense light from one or more areas within the space, so as to provide coverage for the entire space. In this way, motion into and out of area B may be detected by luminaire #1, and other areas by other luminaires. Numerous permutations can be configured, as will be appreciated. Note that the luminaires, such as luminaire #1, may have other sensors with FOVs limited to other areas within the space, and thus may be able to detect motion in multiple areas. Also, because of the ID signals encoded in the reflected light, luminaires can detect the sources of the reflected light and can thereby detect motion in specific areas of the space illuminated by the light sources, even if the FOV of a sensor is not necessarily limited by a lightguide.

FIG. 6B illustrates a perspective view of an example human detection and tracking system using reflected light, in accordance with an embodiment of the present disclosure. In this example, the system is as described in FIG. 6A. From this perspective, transmitted light from luminaire #4 can be seen entering and reflecting off area B. The reflected light, encoded with the ID signal of luminaire #4, reflects from area B towards luminaire #1 and its lightguided photosensor. In this example, the lightguide for the photosensor of luminaire #1 limits the FOV of that photosensor to area B. Note that the shape of a lightguide (square, rectangular, circular, or other suitable shape) on a photosensor effectively determines the shape of the FOV covered by the sensor. Here, the lightguide is rectangular in shape, and thus area B is generally rectangular as well.

In the example of FIG. 6C, the system is as described in FIG. 6A and 6B. As can be seen, a human has moved into area B. Human presence and motion within area B may be sensed by luminaire #1 due to changes in reflected light received at the lightguided photosensor of luminaire #1. Note that the occupant may either reflect light differently to luminaire #1, or block light from reflecting to luminaire #1. Either way, the occupant causes a change in the reflected light profile.

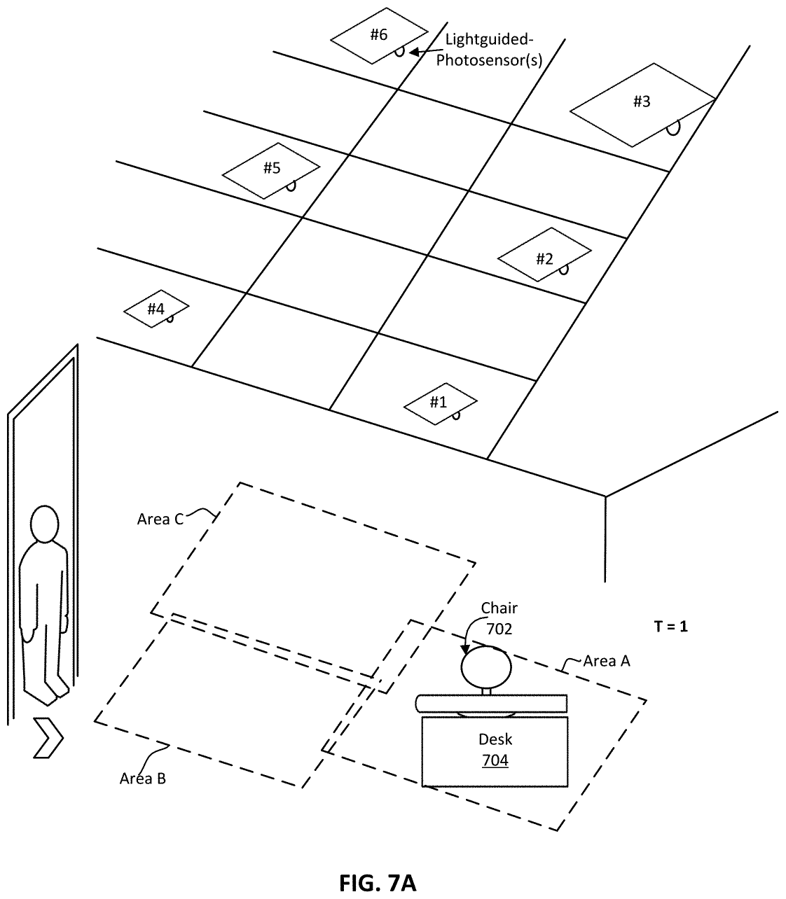

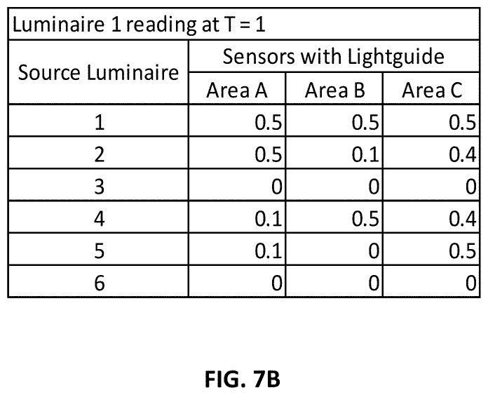

FIGS. 7A-B through 10A-B collectively illustrate another example use case of human detection and tracking over a period of time according to an embodiment, by way of perspective views and corresponding charts that show sensor data readings from the various luminaires in the area. Just as with the example use cases depicted in FIGS. 5A-B and 6A-C, the luminaires can be executing, for instance, the method of FIG. 4, although variations will be appreciated in light of this disclosure.

As can be seen in FIG. 7A, the system is configured in a similar fashion in that it includes six luminaires labeled #1 through #6, and the space being monitored is divided into areas, including areas A, B, C, and so on. Note that the areas may overlap with one another, or not, and that is ok. As will be appreciated, an overlap area allows for more data to be used in confirming occupancy of that area. In addition, all luminaires in this example embodiment are LCom-enabled with one or more lightguided photosensors (such as visible light sensor 165 and/or invisible light sensor 181). So, for instance, each luminaire has a photosensor with a lightguiding cap that limits the sensing FOV of that particular sensor to a corresponding one of the areas marked A, B, or C.

As can be further seen in FIG. 7A, at time T=1, an occupant is about to enter the space, but has not yet entered. All six luminaires are transmitting light encoded (visible and/or invisible) with their own unique source ID into the space, including into areas A, B, and C, such as shown in FIGS. 6A-C. In addition, at least some of the luminaires are receiving light reflected from at least one corresponding area within the currently unoccupied space. For instance, as can generally be seen with reference to FIG. 7B, luminaire # 1 is sensing reflected light from areas A, B, and C in this example case. Each of the other luminaires (#s 2 through 6) can have a similar chart showing areas and light sources from which those respective luminaires receive reflected light, and the corresponding sensor data. Note that there may be other areas with the space being monitored, in addition to A, B, and C, from which light can be reflected. Further note that the presence and location of desk 704 and chair 702 may affect light reflections, for instance, in area A. As will be further appreciated, the sensor data indicated in the table of FIG. 7B indicates a baseline for the current state of areas A, B, and C of the unoccupied space as “seen” by the photosensor of luminaire # 1. Further note that this baseline includes the current position of chair 702, which is a moveable object. The values listed in the table may be, for instance, an average intensity levels or signal amplitudes, as derived from one or more detection signals generated by the photosensor, or a single intensity level or signal amplitude as generated by the photosensor. These values can be stored or otherwise maintained in a database accessible to processor(s) carrying out the methodology.

As can be further seen from FIGS. 7A-B, the position of the source luminaire relative to sensing luminaire may affect the sensor reading obtained. For example, the sourcing luminaire #s 3 and 6 are furthest from receiving luminaire #1, and thus a reading of 0.0 is obtained at luminaire #1 because insufficient light from luminaire #s 3 and 6 is reflected toward luminaire #1. In a similar fashion, reflected light from the luminaire # 5 is blocked by the lightguide associated with receiving luminaire #1, and thus a reading of 0.0 is obtained at luminaire #1 because is received from luminaire #5. As can be further seen in FIG. 7b, the strongest signals detected by luminaire #1 are the luminaire #1 light reflected signals from each of areas A, B, and C, in this particular example scenario.

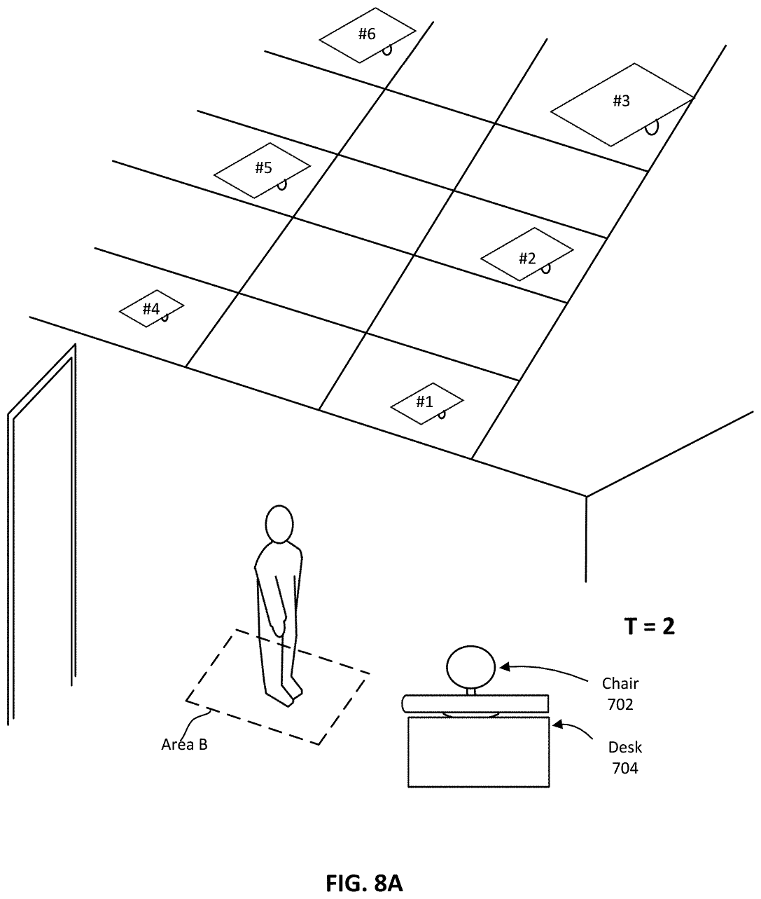

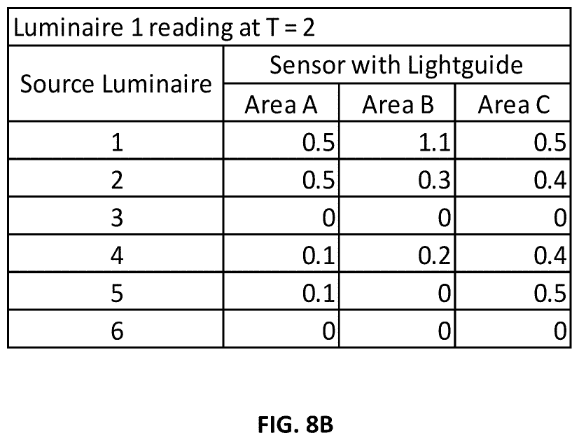

As shown in FIG. 8A, the occupant has now entered the monitored space at T=2, specifically area B. As discussed in FIG. 7A, all luminaires are transmitting their own unique ID as light into the space. How the presence of the occupant in area B affects the reflected light profile will largely depend on the reflectivity of the occupant (e.g., occupant's head and clothing). In some cases, for instance, the occupant may actually mostly block reflected light that is normally received by luminaire #1, thereby causing a smaller (lower magnitude/amplitude) detection signal. In other cases, the occupant may actually mostly reflect light that is normally reflected to luminaire #1 from a greater distance or not at all, thereby causing a larger (greater magnitude/amplitude) detection signal. For example, and as can be seen in the example sensor data change depicted in FIGS. 7B and 8B, the occupant is reflective and causes an increase in the detection signal strength (an increase from 0.5 to 1.1), based on light from luminaire #1 that is reflected from area B back to the lightguided-photosensor of luminaire #1. The reading from source luminaire 2 has also increased, from 0.1 to 0.3. Note, the reading from source luminaire 4 has decreased, from 0.5 to 0.2. This decrease may still indicate an occupancy in area B due to a change in a variety of factors, for example, the occupant may be blocking more of the light from source luminaire 4, resulting in a decrease in the reflected light reaching the sensor of luminaire #1.

In any such cases, changes in the baseline reflection profile that are greater than a given threshold for a given area can be used to indicate a change in occupancy of that area. For instance, and as previously explained with reference to FIGS. 1 and 4, luminaire #1 (or computing device 200, or server 300) may compare the reflected signal data in area B with a previously determined baseline data (e.g., 1.1-0.5=0.6), determine that the reflected light from area B at T=2 is not within the similarity threshold of the baseline (e.g., 0.6 is >Threshold, with Threshold being 0.25 or less), send a signal indicating occupancy of area B (e.g., to turn on visible lighting, or additional visible lighting, for area B), and update the baseline with the current sensor readings at T=2 (e.g., store table from FIG. 8B over table from FIG. 7B in a database).

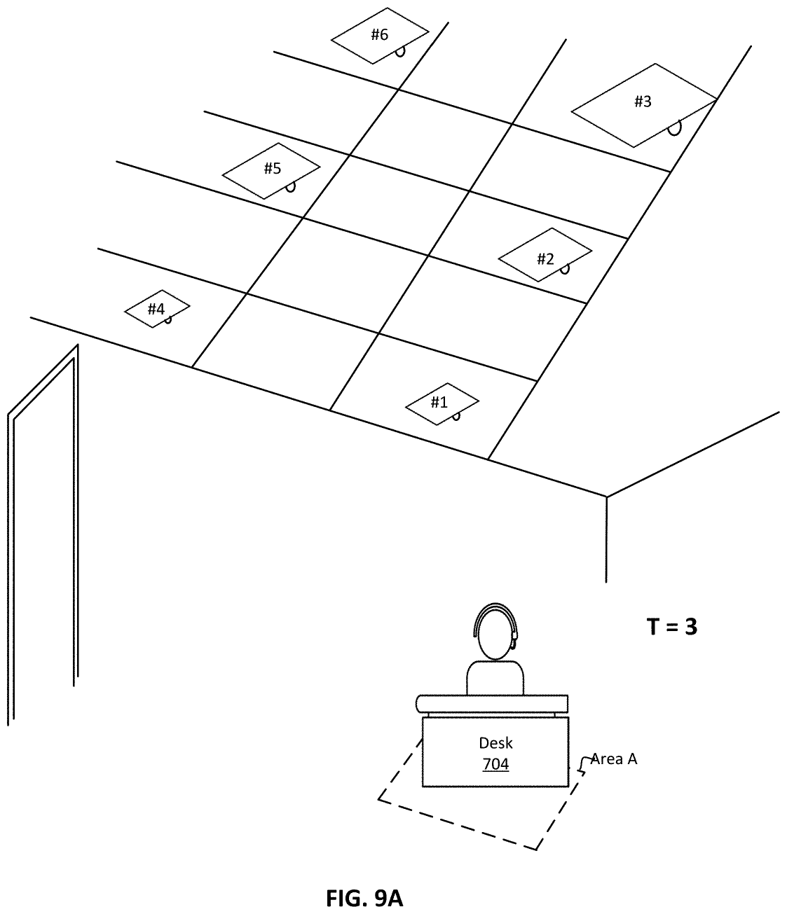

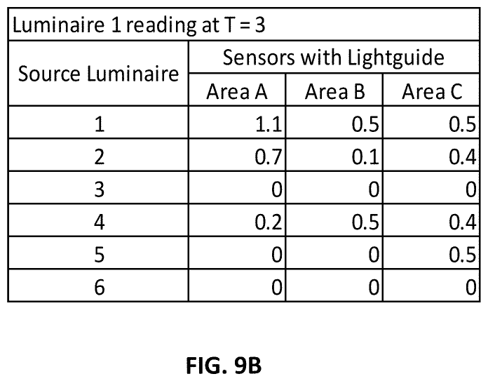

As shown at T=3 in FIG. 9A, the occupant is now seated at desk 704, which is located in area A. Just as explained with reference to FIGS. 8A-B, light may reflect off the occupant and/or be blocked by the occupant, which results in different readings by sensors with a FOV in area A, as detected by the methodology (e.g., FIG. 4). The sensor readings indicated in FIG. 9B show a number of things. For instance, the reflection signal received by luminaire #1 from area B has now decreased from 1.1 back to its original baseline value of 0.5, whereas the reflection signal received by luminaire #1 from area A has increased from 0.5 to 1.1. This likely indicates that the occupant has moved from area B to area A. Note, using the baseline from T=1 would give a false reading of no motion in area B, as the static environment in area B at T=3 is the same as at T=1 in this example scenario; however, between T=2 and T=3 the human moved out of area B and into area A. Thus, the system now has received indication of movement in the space in area B at T=2 and T=3, and movement in area A at T=3. In this way, by timely updating the baseline, the system is able to track motion across the space over time. Furthermore, if the occupant remains at desk 704 without triggering motion detection by altering the light reflections in area A, human presence may be inferred because the system tracked motion into area A but has yet to track motion out of area A.

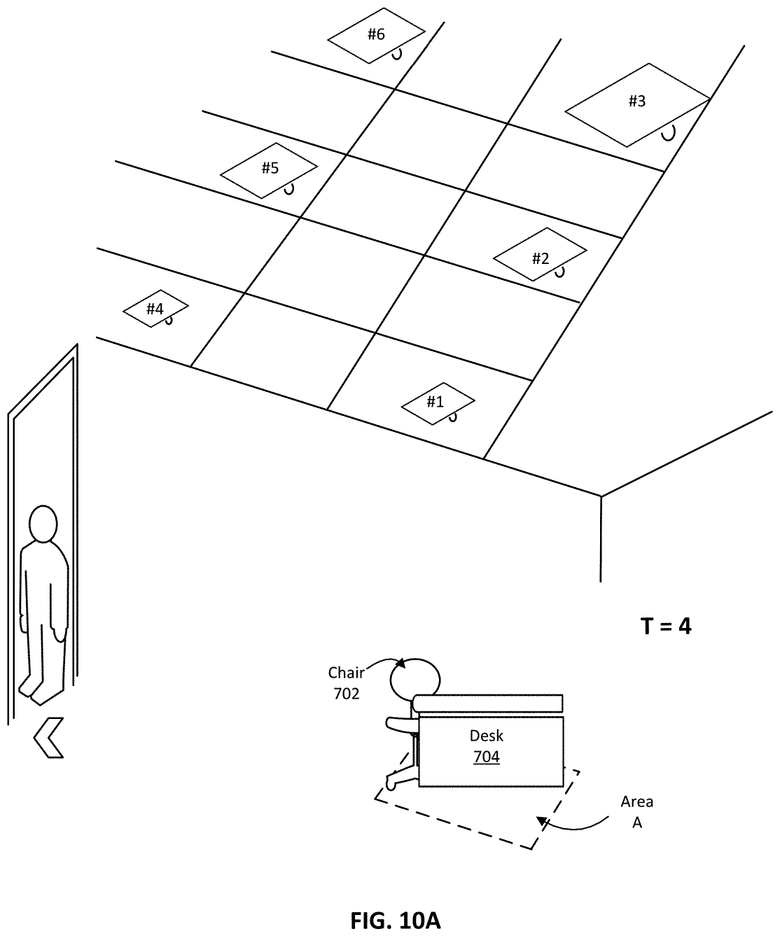

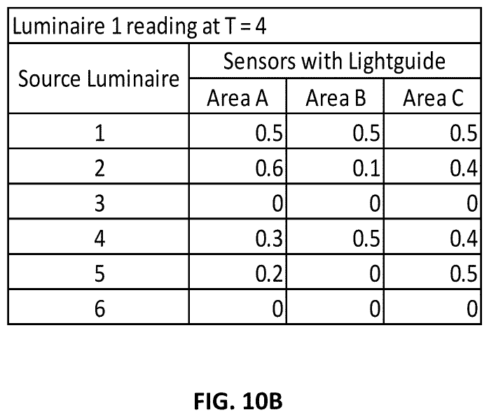

As shown at T=4 in FIG. 10A, the occupant has left area A and exited the monitored space via a doorway. So, in the corresponding table of FIG. 10B, note that the reflection signal received by luminaire #1 from area A has now decreased from 1.1 back to its original baseline value of 0.5, in this example scenario. Further note that the occupant has moved chair 702 to a different location in area A from where it was at T=1. As such, the sensor readings at luminaire #1 for area A at T=4 are different than the sensor readings at luminaire #1 for area A at T=1. This change will be captured into the baseline at 416, as previously explained. As will be further appreciated, note that the occupant may have been tracked as having passed through area B and/or C in moving from desk 704 to the doorway, and tracking of such intermediate movement will be apparent in light of this disclosure (e.g., computed via methodology of FIG. 4). On the other hand, readings from light reflected off area B have not changed relative to T=3, and therefore, a static environment may be inferred.

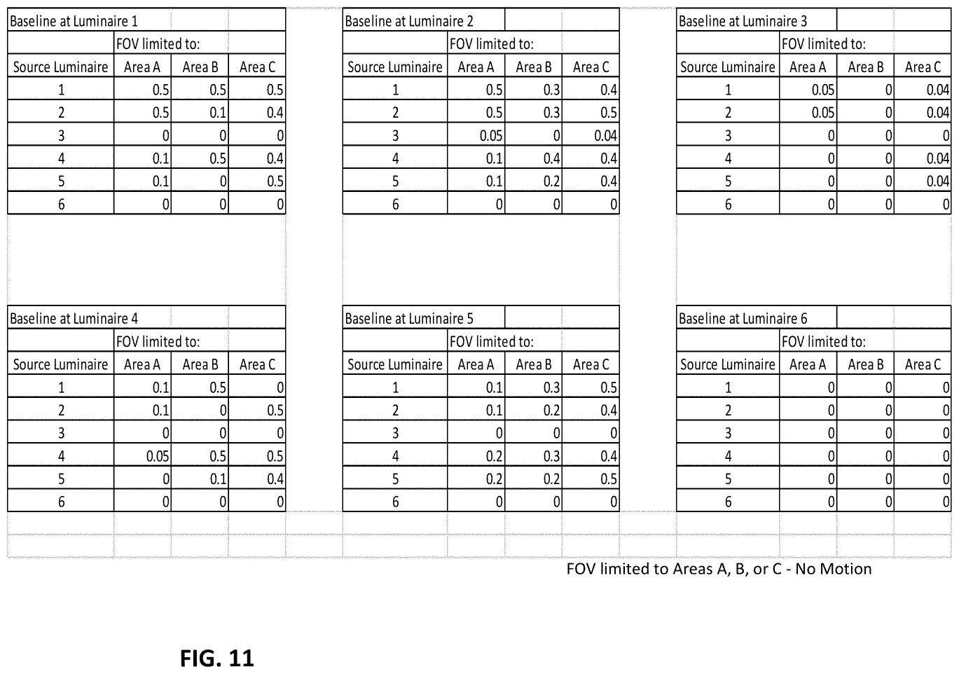

FIG. 11 illustrates a set of tables showing an example of sensor data readings from all luminaires of a given system in a given space at a given time, in accordance with an embodiment of the present disclosure. As can be seen, this example embodiment includes six luminaires (1-6), each associated with photosensors with FOVs limited to areas A, B, and C within the monitored space. Each luminaire 1-6 is transmitting light encoded with a source identifying signal into the space. The values in the charts represent associated sensor readings of the received reflected light at each luminaire, for a given occupancy state (occupied or unoccupied). Changes in the readings over time may be utilized to track movement in the monitored space, as variously explained herein. Further note that multiple occupants can be identified and tracked within the space.

FIG. 12 is an oscilloscope plot that represents a reflected light signal as received by the photosensor of an LCom-enabled luminaire from an unoccupied area, in accordance with an embodiment of the present disclosure. The plot 1202 shows the amplitude of the received reflected signal in the time domain, as viewed by an oscilloscope, in a static environment (when no one is moving within the detection area of the photosensor). As can be seen, the reflected signal's amplitude remains almost constant (the discrete change between two values is due to modulation of the source identifying signal). FIG. 13 is an oscilloscope plot that represents a reflected light signal as received by the photosensor of an LCom-enabled luminaire from an area where an occupant is present, in accordance with an embodiment of the present disclosure. The plot 1302 clearly shows a non-trivial change in the amplitude over time in response to changes in the occupancy state within the detection area of the photosensor receiving the reflected signal. The modulation of the source identifying signal may also be seen in the smaller changes within the overall signal in this example.

In addition, and as previously explained, in some embodiments, the shape of the detection signal generated by the photosensor (such as seen and measured on, for instance, an oscilloscope as shown in FIG. 13, or other signal analysis tool) may be used to extract additional information that can identify the type of motion (e.g., speed and dwell time) attributable to the detected occupant. For example, the speed of the occupant can be extracted from the change of the signal amplitude over time. In more detail, as shown in the example plot depicted in FIG. 13, if the dip/drop in amplitude was narrower (with respect to the horizontal time axis), a faster motion can be inferred. So, in the example case shown, the dip in amplitude is about 1.5 vertical divisions and spans about 8 horizontal divisions. Thus, given 100 milliseconds (ms) per division for the horizontal time axis, the width of the amplitude dip is about 800 ms wide. This width of 800 ms can be correlated, for example, to a regular or average pace walk. In a scenario where the occupant is jogging or walking rapidly, the dip in amplitude would still be about 1.5 vertical divisions but would span, for example, only about 4 horizontal divisions to provide a width of about 400 ms. This width of 400 ms could be correlated to a jog or fast pace walk. Such correlations can be computed, for example, based on empirical or anecdotal data, or based on theoretical models and assumptions.

Likewise, the time an occupant remains or dwells in a given location can be determined from the absolute width of the amplitude dip, which may be any amount of time (seconds to many minutes or even hours, depending on the activity of the occupant). This is because the sensor signal amplitude will remain in the dipped position for as long as the occupant remains in that location. This duration can be correlated to a time of occupancy, as will be appreciated. In other embodiments, note that occupancy may trigger an upward going pulse rather than a downward going dip, but still allow for comparable functionality as variously provided herein. In either case, the dip (or pulse) width over time can be used to determine qualities or type of the occupant's movement. Said differently, the duration of the change in amplitude of a detection signal generated by the photosensor can be correlated to a time of occupancy, as will be appreciated.

Various implementations disclosed herein include an occupancy detection system including a first light source for emitting light into an area, a photosensor for detecting a reflected light signal from within the area, in which the reflected light signal includes light emitted by one or more of a plurality of light sources including the first light source and each of the plurality of light sources has an associated identifier, and a processor communicatively coupled to the first light source and the photosensor, in which the processor is configured to encode the light emitted from the first light source with its associated identifier, determining data representing the reflected light signal, in which the data includes identifiers associated with each light source contributing to the reflected light signal, compare the data representing the reflected light signal with data representing a current baseline, and detect a change in occupancy and/or movement in the area based on the comparison.

In some embodiments, the photosensor is configured to detect visible light. In some embodiments, the first light source includes one or more light emitting diodes. In some embodiments, the processor is configured to detect a change in occupancy and/or movement in the area based on the comparison by calculating a first value representing the reflected light signal, calculating a second value representing the current baseline, determining whether a difference between the first value and the second value exceeds a threshold, and detecting a change in occupancy and/or movement in the area when the difference between the first value and the second value exceeds the threshold. In some embodiments, the processor is further configured to update the current baseline based on the reflected light signal. In some embodiments, the processor is further configured to determine at least one of a speed of movement or a duration of occupancy based on the reflected light signal. In some embodiments, the system further includes a lightguide configured to limit the field of view of the photosensor to a sub-area within the area. In some embodiments, the processor is further configured to control a building system in response to detecting a change in occupancy and/or movement in the area. In some embodiments, the building system includes one of a lighting system, a HVAC system, safety/alarm system, and a surveillance/monitoring system.

Other implementations disclosed herein include an occupancy detection method, including receiving, from a photosensor, a reflected light signal within an area, in which the reflected light signal includes light emitted by one or more of a plurality of light sources and each of the plurality of light sources has an associated identifier, determining, by a processor, data representing the reflected light signal, in which the data includes identifiers associated with each light source contributing to the reflected light signal, comparing, by the processor, the data representing the reflected light signal with data representing a current baseline, and detecting, by the processor, a change in occupancy and/or movement in the area based on the comparison.

In some embodiments, the method further includes encoding, by the processor, a light signal emitted by a first light source in the plurality of light sources with its associated identifier. In some embodiments, the first light source includes one or more light emitting diodes. In some embodiments, the photosensor is configured to detect visible light. In some embodiments, detecting a change in occupancy and/or movement in the area based on the comparison includes calculating, by the processor, a first value representing the reflected light signal, calculating, by the processor, a second value representing the current baseline, determining, by the processor, whether a difference between the first value and the second value exceeds a threshold, and detecting, by the processor, a change in occupancy and/or movement in the area when the difference between the first value and the second value exceeds the threshold. In some embodiments, the method further includes updating, by the processor, the current baseline based on the reflected light signal. In some embodiments, the method further includes determining, by the processor, at least one of a speed of movement or a duration of occupancy based on the reflected light signal. In some embodiments, the photosensor is operatively coupled with a lightguide configured to limit the field of view of the photosensor to a sub-area within the area. In some embodiments, the method further includes controlling, by the processor, a building system in response to detecting a change in occupancy and/or movement in the area. In some embodiments, the building system includes one of a lighting system, a HVAC system, safety/alarm system, and a surveillance/monitoring system.

Other implementations disclosed herein include a non-transitory machine readable medium encoded with instructions that when executed by one or more processors cause a process to be carried out for occupancy detection, the process including receiving, from a photosensor, a reflected light signal within an area, in which the reflected light signal includes light emitted by one or more of a plurality of light sources, and each of the plurality of light sources has an associated identifier, determining data representing the reflected light signal, in which the data includes identifiers associated with each light source contributing to the reflected light signal, comparing the data representing the reflected light signal with data representing a current baseline, and detecting a change in occupancy and/or movement in the area based on the comparison.

The foregoing description of the embodiments of the present disclosure has been presented for the purposes of illustration and description. It is not intended to be exhaustive or to limit the present disclosure to the precise form disclosed. Many modifications and variations are possible in light of this disclosure. It is intended that the scope of the present disclosure be limited not by this detailed description, but rather by the claims appended hereto.

What is claimed is:

1. An occupancy detection system comprising:
a first light source for emitting light into an area;
a photosensor for detecting a reflected light signal from within the area, wherein:
the reflected light signal comprises light emitted by one or more of a plurality of light sources including the first light source; and
each of the plurality of light sources has an associated identifier; and
a processor communicatively coupled to the first light source and the photosensor, wherein the processor is configured to:
encode the light emitted from the first light source with its associated identifier;
determining data representing the reflected light signal, wherein the data includes identifiers associated with each light source contributing to the reflected light signal;
compare the data representing the reflected light signal with data representing a current baseline; and
detect a change in occupancy and/or movement in the area based on the comparison.

2. The system of claim 1, wherein the photosensor is configured to detect visible light.

3. The system of claim 1, wherein the first light source comprises one or more light emitting diodes.

4. The system of claim 1, wherein the processor is configured to detect a change in occupancy and/or movement in the area based on the comparison by:
calculating a first value representing the reflected light signal;
calculating a second value representing the current baseline;
determining whether a difference between the first value and the second value exceeds a threshold; and
detecting a change in occupancy and/or movement in the area when the difference between the first value and the second value exceeds the threshold.

5. The system of claim 1, wherein the processor is further configured to update the current baseline based on the reflected light signal.

6. The system of claim 1, wherein the processor is further configured to determine at least one of a speed of movement or a duration of occupancy based on the reflected light signal.

7. The system of claim 1, further comprising a lightguide configured to limit the field of view of the photosensor to a sub-area within the area.

8. The system of claim 1, wherein the processor is further configured to control a building system in response to detecting a change in occupancy and/or movement in the area.

9. The system of claim 8, wherein the building system comprises one of a lighting system, a HVAC system, safety/alarm system, and a surveillance/monitoring system.

10. An occupancy detection method comprising:
receiving, from a photosensor, a reflected light signal within an area, wherein:
the reflected light signal comprises light emitted by one or more of a plurality of light sources; and
each of the plurality of light sources has an associated identifier;
determining, by a processor, data representing the reflected light signal, wherein the data includes identifiers associated with each light source contributing to the reflected light signal;
comparing, by the processor, the data representing the reflected light signal with data representing a current baseline; and
detecting, by the processor, a change in occupancy and/or movement in the area based on the comparison.

11. The method of claim 10, further comprising:
encoding, by the processor, a light signal emitted by a first light source in the plurality of light sources with its associated identifier.

12. The method of claim 11, wherein the first light source comprises one or more light emitting diodes.

13. The method of claim 10, wherein the photosensor is configured to detect visible light.

14. The method of claim 10, wherein detecting a change in occupancy and/or movement in the area based on the comparison comprises:
calculating, by the processor, a first value representing the reflected light signal;
calculating, by the processor, a second value representing the current baseline;
determining, by the processor, whether a difference between the first value and the second value exceeds a threshold; and
detecting, by the processor, a change in occupancy and/or movement in the area when the difference between the first value and the second value exceeds the threshold.

15. The method of claim 10, further comprising updating, by the processor, the current baseline based on the reflected light signal.

16. The method of claim 10, further comprising determining, by the processor, at least one of a speed of movement or a duration of occupancy based on the reflected light signal.

17. The method of claim 10, wherein the photosensor is operatively coupled with a lightguide configured to limit the field of view of the photosensor to a sub-area within the area.

18. The method of claim 10, further comprising controlling, by the processor, a building system in response to detecting a change in occupancy and/or movement in the area.

19. The method of claim 18, wherein the building system comprises one of a lighting system, a HVAC system, safety/alarm system, and a surveillance/monitoring system.

20. A non-transitory machine readable medium encoded with instructions that when executed by one or more processors cause a process to be carried out for occupancy detection, the process comprising:
receiving, from a photosensor, a reflected light signal within an area, wherein:
the reflected light signal comprises light emitted by one or more of a plurality of light sources; and
each of the plurality of light sources has an associated identifier;
determining data representing the reflected light signal, wherein the data includes identifiers associated with each light source contributing to the reflected light signal;
comparing the data representing the reflected light signal with data representing a current baseline; and
detecting a change in occupancy and/or movement in the area based on the comparison.
